(19) United States
(12) Patent Application Publication
(10) Pub. No.: US 2025/0102403 A1
(43) Pub. Date: Mar. 27, 2025

(54) SYSTEMS AND METHODS OF TRAINING AND USING A REDUCED ORDER MODEL TO ESTIMATE TURBOMACHINE CLEARANCES

(71) Applicant: GE Infrastructure Technology LLC, Greenville, SC (US)

(72) Inventors: Donald Earl Floyd, Greenville, SC (US); Brett Darrick Klingler, Greenville, SC (US)

(21) Appl. No.: 18/474,651

(22) Filed: Sep. 26, 2023

(51) Int. Cl. G01M 15/14

(52) U.S. Cl. CPC G01M 15/14

(57) ABSTRACT

A system for estimating clearances of a turbomachine is provided. The system includes one or more processors configured to perform operations include outputting an estimated bulk temperature. The operations further include determining a filtered bulk temperature. The filtered bulk temperature being determined based at least in part on the estimated bulk temperature and a measured bulk temperature. The measured bulk temperature being determined independently of the trained ROM. The operations further include determining, at a clearance estimator for each clearance of interest of the turbomachine, an estimated clearance. The estimated clearance for a given clearance of interest of the clearances of interest being determined based at least in part on the filtered bulk temperatures associated with the region of interest in which the given clearance of interest is positioned. The operations further include performing a control action based at least in part on the estimated clearances.

### FIELD

The present disclosure relates generally to systems and methods of estimating clearances of turbomachines using a reduced order model.

### BACKGROUND

Gas turbines (e.g., gas turbine engines) are utilized in a variety of industries and applications for energy transfer purposes. A gas turbine generally includes a compressor section, a combustion section, a turbine section, and an exhaust section. The compressor section progressively increases the pressure of a working fluid entering the gas turbine and supplies this compressed working fluid to the combustion section. The compressed working fluid and a fuel (e.g., natural gas) mix within the combustion section and burn in a combustion chamber to generate high pressure and high temperature combustion gases. The combustion gases flow from the combustion section into the turbine section where they expand to produce work. For example, expansion of the combustion gases in the turbine section may rotate a rotor shaft connected, e.g., to a generator to produce electricity. The combustion gases then exit the gas turbine via the exhaust section.

A gas turbine can define a plurality of clearances such as between a rotating component and a stationary component or between two stationary components. As one example, a clearance can be defined between a rotating turbine blade and a stationary shroud. Optimization of clearances of a gas turbine can lead to better engine performance and efficiency. Moreover, knowing or accurately estimating clearances can also be useful for predicting and/or preventing rub events where one component rubs against another, estimating head room and time needed for restarts, for lifing and/or prognostic health management (e.g., estimating component lifecycle based on operating hours and conditions), and/or adjusting control of the gas turbine. Conventionally, estimating clearances has been challenging and time consuming.

Accordingly, improved techniques for estimating clearances of a gas turbine would be a welcome addition to the art.

### BRIEF DESCRIPTION

Aspects and advantages of the systems and methods in accordance with the present disclosure will be set forth in part in the following description, or may be obvious from the description, or may be learned through practice of the technology.

In accordance with one embodiment, a system for estimating clearances of a turbomachine is provided. The system includes one or more memory devices and one or more processors. The one or more processors are configured to perform operations that include outputting, from a trained reduced order model (ROM) for each region of interest of one or more components of interest of the turbomachine, an estimated bulk temperature. The operations further include determining, at a validation module for each of the regions of interest, a filtered bulk temperature. The filtered bulk temperature of a given component of interest of the one or more components of interest in a given region of interest of the regions of interest being determined based at least in part on the estimated bulk temperature and a measured bulk temperature each associated with the given component of interest at the given region of interest. The measured bulk temperature being determined independently of the trained ROM. The operations further include determining, at a clearance estimator for each clearance of interest of the turbomachine, an estimated clearance. The estimated clearance for a given clearance of interest of the clearances of interest being determined based at least in part on the filtered bulk temperatures associated with the region of interest in which the given clearance of interest is positioned. The operations further include performing a control action based at least in part on the estimated clearances.

In accordance with another embodiment, a method of estimating clearances of a turbomachine is provided. The method includes outputting, from a reduced order model for each region of interest of one or more components of interest of the turbomachine, an estimated bulk temperature. The method further includes determining, at a validation module for each of the regions of interest of the one or more components of interest, a filtered bulk temperature. The filtered bulk temperature for a given region of interest of the regions of interest being determined based at least in part on the estimated bulk temperature and a measured bulk temperature determined independently from the reduced order model. The method further includes determining, at a clearance estimator, estimated clearances for respective clearances of interest of the turbomachine based at least in part on the filtered bulk temperatures. The method further includes performing a control action based at least in part on the estimated clearances.

In accordance with yet another embodiment, a non-transitory computer readable medium having computer-executable instructions, which, when executed by one or more processors of a computing system associated with a turbomachine, cause the one or more processors to perform operations. The operations include outputting, from a trained reduced order model (ROM) for each region of interest of one or more components of interest of the turbomachine, an estimated bulk temperature. The operations further include determining, at a validation module for each of the regions of interest, a filtered bulk temperature. The filtered bulk temperature of a given component of interest of the one or more components of interest in a given region of interest of the regions of interest being determined based at least in part on the estimated bulk temperature and a measured bulk temperature each associated with the given component of interest at the given region of interest. The measured bulk temperature being determined independently of the trained ROM. The operations further include determining, at a clearance estimator for each clearance of interest of the turbomachine, an estimated clearance. The estimated clearance for a given clearance of interest of the clearances of interest being determined based at least in part on the filtered bulk temperatures associated with the region of interest in which the given clearance of interest is positioned. The operations further include performing a control action based at least in part on the estimated clearances.

These and other features, aspects and advantages of the present systems and methods will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present subject matter, including the best mode thereof, directed to one of ordinary skill in the art, is set forth in the specification, which makes reference to the appended figures, in which:

FIG. 1 provides a schematic cross-sectional view of a turbomachine embodied as a gas turbine in accordance with embodiments of the present disclosure;

FIG. 2 provides a schematic cross-sectional view of a turbine section of the gas turbine of FIG. 1;

FIG. 3 provides a data flow diagram of a reduced order model being trained according to example embodiments of the present disclosure;

FIG. 4 lists equations that can be utilized in training of a reduced order model;

FIG. 5 provides a schematic view of a rotor of a turbomachine and depicts an example manner in which bulk temperatures can be determined for each region of interest associated with the rotor;

FIG. 6 provides a schematic view of a casing of a turbomachine and depicts an example manner in which bulk temperatures can be determined for each region of interest associated with the casing;

FIG. 7 provides a schematic view of the rotor and depicts an example manner in which a hot free stream temperature and a cold free stream temperature of fluid(s) flowing relative to the rotor can be calculated for each region of interest associated with the rotor;

FIG. 8 provides a schematic view of the casing and depicts an example manner in which a hot free stream temperature and a cold free stream temperature of fluid(s) flowing relative to the casing can be calculated for each region of interest associated with the casing;

FIG. 9 provides a schematic view of fluid streams flowing relative to a component of interest in a particular region of interest;

FIG. 10 provides a graph depicting a cooling/heating effectiveness as a function of a number of transfer units;

FIG. 11 provides a schematic view of the rotor and depicts an example manner in which nodal cooling/heating effectivenesses can be determined for nodes defined for each region of interest associated with the rotor;

FIG. 12 provides a schematic view of the casing and depicts an example manner in which nodal cooling/heating effectivenesses can be determined for nodes defined for each region of interest associated with the casing;

FIG. 13 provides a flow diagram for a method of training a reduced order model operable to output estimates usable for determining clearances of a turbomachine;

FIG. 14 provides a data flow diagram for using a reduced order model trained to output estimates that can be used to determine clearances for a turbomachine;

FIG. 15 lists a number of equations associated with using a reduced order model to output estimates that can be used to determine clearances for a turbomachine;

FIG. 16 provides a graph depicting example distributions generated by a Kalman filter for a given region of interest of a component of interest;

FIG. 17 provides a graph depicting example distributions generated by a clearance Kalman filter for a given region of interest of a component of interest;

FIG. 18 provides a data flow diagram of a restart analyzer implementing a restart analysis for a gas turbine according to example embodiments of the present disclosure;

FIG. 19 provides a flow diagram for a method of training a reduced order model operable to output estimates usable for determining clearances of a turbomachine; and

FIG. 20 provides a system diagram of a computing system according to example embodiments of the present disclosure.

### DETAILED DESCRIPTION

Reference now will be made in detail to embodiments of the present subject matter, one or more examples of which are illustrated in the drawings. Each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents.

The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components.

The term “fluid” may be a gas or a liquid. The term “fluid communication” means that two or more areas defining a flow passage are joined to one another such that a fluid is capable of making the connection (i.e., flowing) between the areas specified.

As used herein, the terms “upstream” (or “forward”) and “downstream” (or “aft”) refer to the relative direction with respect to fluid flow in a fluid pathway. For example, “upstream” refers to the direction from which the fluid flows, and “downstream” refers to the direction to which the fluid flows. However, the terms “upstream” and “downstream” as used herein may also refer to a flow of electricity.

The term “radially” refers to the relative direction that is substantially perpendicular to an axial centerline of a particular component; the term “axially” refers to the relative direction that is substantially parallel and/or coaxially aligned to an axial centerline of a particular component; and the term “circumferentially” refers to the relative direction that extends around the axial centerline of a particular component.

Terms of approximation, such as “about,” “approximately,” “generally,” and “substantially,” are not to be limited to the precise value specified. In at least some instances, the approximating language may correspond to the precision of an instrument for measuring the value, or the precision of the methods or machines for constructing or manufacturing the components and/or systems. In at least some instances, the approximating language may correspond to the precision of an instrument for measuring the value, or the precision of the methods or machines for constructing or manufacturing the components and/or systems. For example, the approximating language may refer to being within a 1, 2, 4, 5, 10, 15, or 20 percent margin in either individual values, range(s) of values and/or endpoints defining range(s) of values. When used in the context of an angle or direction, such terms include within ten degrees greater or less than the stated angle or direction. For example, “generally vertical” includes directions within ten degrees of vertical in any direction, e.g., clockwise or counter-clockwise.

The terms “coupled,” “fixed,” “attached to,” and the like refer to both direct coupling, fixing, or attaching, as well as indirect coupling, fixing, or attaching through one or more intermediate components or features, unless otherwise specified herein.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “and/or” refers to a condition satisfied by any one of the following: A is true (or present) and B is false (or not present), A is false (or not present) and B is true (or present), and both A and B are true (or present).

Here and throughout the specification and claims, where range limitations are combined and interchanged, such ranges are identified and include all the sub-ranges contained therein unless context or language indicates otherwise. For example, all ranges disclosed herein are inclusive of the endpoints, and the endpoints are independently combinable with each other.

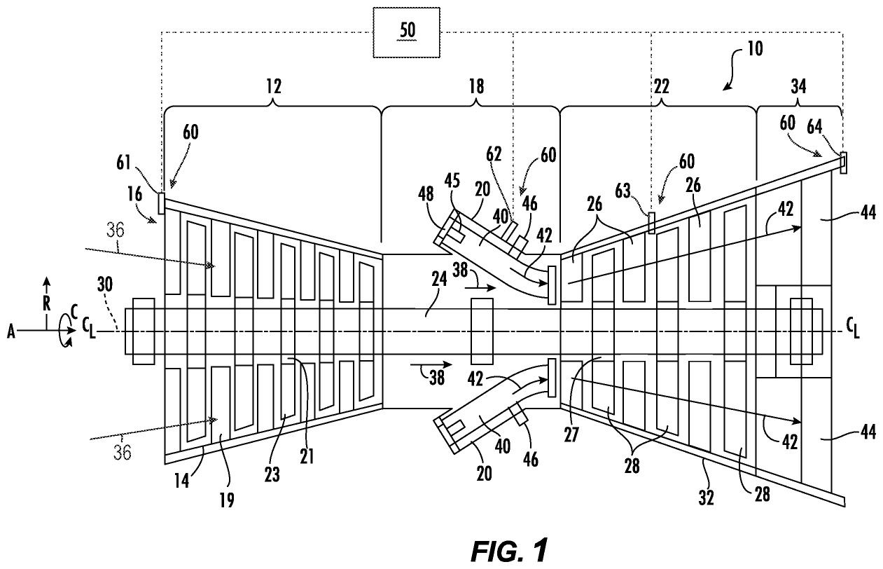

Referring now to the drawings, FIG. 1 illustrates a schematic cross-sectional view of one embodiment of a turbomachine, which in the illustrated embodiment is a gas turbine 10. Although an industrial or land-based gas turbine is shown and described herein, the present disclosure is not limited to industrial and/or land-based gas turbines unless otherwise specified in the claims. For example, the inventive aspects described herein may be used in or apply to any type of turbomachine, including, but not limited to, a steam turbine, an aircraft gas turbine, or a marine gas turbine.

For reference, the gas turbine 10 defines a cylindrical coordinate system having an axial direction A extending along an axial centerline 30 of the gas turbine 10, a radial direction R perpendicular to the axial centerline 30, and a circumferential direction C extending around the axial centerline 30.

As shown in FIG. 1, the gas turbine 10 includes a compressor section 12 that includes a compressor 14. The compressor 14 includes an inlet 16 that is disposed at an upstream end of the gas turbine 10. The gas turbine 10 further includes a combustion section 18 having one or more combustors 20 disposed downstream of the compressor section 12. The gas turbine 10 also includes a turbine section 22 disposed downstream of the combustion section 18. A rotor 24 extends generally axially through the gas turbine 10.

The compressor section 12 generally includes a plurality of rotor disks 21 and a plurality of rotor blades 23. Each rotor blade 23 extends radially outward from and is connected to a respective one of the plurality of rotor disks 21. Each rotor disk 21 is coupled to or forms a portion of the rotor 24 that extends through the compressor section 12. Additionally, the compressor section 12 includes a plurality of stator vanes 19 extending from a compressor casing. The rotor blades 23 and the stator vanes 19 of the compressor section 12 include airfoils that define an airfoil shape (e.g., having a leading edge, a trailing edge, and side walls extending between the leading edge and the trailing edge). Further, for the depicted embodiment of FIG. 1, each compressor stage includes a circumferential array of stator vanes and a circumferential array of rotor blades disposed downstream of the stator vanes.

The turbine section 22 includes a plurality of rotor disks 27 and a plurality of rotor blades 28 extending radially outward from and being interconnected to respective rotor disks 27. Each rotor disk 27 in turn may be coupled to or form a portion of the rotor 24 that extends through the turbine section 22. The turbine section 22 further includes an outer casing 32 that circumferentially surrounds a downstream portion of the rotor 24 and the rotor blades 28. The turbine section 22 can include stator vanes or stationary nozzles 26 extending radially inward from the outer casing 32. The rotor blades 28 and stator vanes 26 may be arranged in alternating fashion to define expansion stages along the axial centerline 30 of gas turbine 10. Both the rotor blades 28 and the stator vanes 26 can include airfoils that define an airfoil shape (e.g., having a leading edge, a trailing edge, and side walls extending between the leading edge and the trailing edge).

In operation, ambient air 36 or other working fluid is drawn into the inlet 16 of the compressor 14 and is progressively compressed to provide a compressed air 38 to the combustion section 18. The compressed air 38 flows into the combustion section 18 and is mixed with fuel in one or more fuel nozzles 45 to form a combustible mixture. The one or more fuel nozzles 45 may be disposed at a forward end of the combustor 20, e.g., coupled to an end cover 48 of the combustor 20. The combustible mixture is burned within a combustion chamber 40 of the combustor 20, thereby generating combustion gases 42 that flow from the combustion chamber 40 into the turbine section 22. In some embodiments, one or more Axial Fuel Stage (AFS) or fuel injectors 46 may be disposed downstream of the fuel nozzles 45. The one or more AFS (secondary) injectors 46 may be in fluid communication with the combustion chamber 40 to inject a second combustible mixture of fuel and air into the combustion chamber 40 downstream of the fuel nozzles 45, such that the combustion chamber 40 has a primary combustion zone (created by the fuel nozzles 45) and a secondary combustion zone (created by the AFS injectors 46). Energy (kinetic and/or thermal) is transferred from the combustion gases 42 to the rotor blades 28, causing the rotor 24 to rotate and produce mechanical work. The energy-depleted combustion gases 42 exit the turbine section 22 as exhaust gases and flow through an exhaust diffuser 34 across a plurality of struts or main airfoils 44 that are disposed within the exhaust diffuser 34.

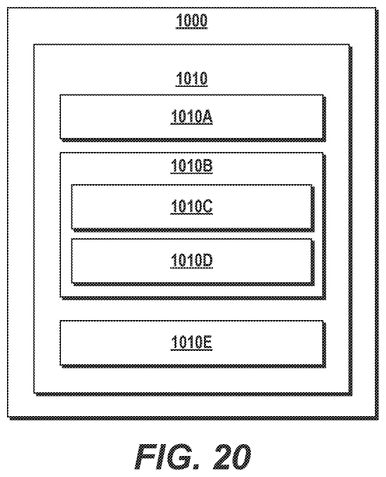

Further, as shown in FIG. 1, the gas turbine 10 can include a computing system 50. The computing system 50 can have one or more processing devices and one or more memory devices, which can be embodied in one or more controllers, for example. The one or more memory devices, such as one or more non-transitory computer readable medium, can store computer-readable instructions that can be executed by the one or more processing devices to perform operations, such as controlling operations of the gas turbine 10, training one or more models, performing lifing analysis of components, etc. The computing system 50 can be positioned onboard the gas turbine 10 (e.g., coupled with an outer casing), offboard the gas turbine 10, or partially onboard and partially offboard. The computing system 50 can be configured as shown in FIG. 20.

The gas turbine 10 can also include one or more sensors 60 for sensing operating parameters or operating characteristics of the gas turbine 10. For the depicted embodiment of FIG. 1, the gas turbine 10 includes a first sensor 61 arranged to sense an operating parameter associated with the compressor section 12, a second sensor 62 arranged to sense an operating parameter associated with the combustion section 12, a third sensor 63 arranged to sense an operating parameter associated with the turbine section 22, and a fourth sensor 64 arranged to sense an operating parameter associated with the exhaust section 34. It will be appreciated that more or less than the number of sensors depicted in FIG. 1 are possible, including more sensors at each section of the gas turbine 10. Example operating parameters include, without limitation, a compressor inlet temp, a compressor exit temperature, an ambient temperature, a turbine inlet temperature, a compressor discharge pressure, ambient pressure, engine speed, a position of a variable geometry component (e.g., an inlet guide vane), etc. The sensors 60 can be communicatively coupled with the computing system 50, e.g., via one or more wired or wireless communication links. Sensed outputs from the sensors 60 can be received by the computing system 50, and the computing system 50 can use the received sensor outputs, e.g., to control various controllable devices of the gas turbine 10.

A gas turbine, such as the gas turbine 10 of FIG. 1, can define a plurality of clearances or distances between adjacent components, such as a distance between a rotating component and a stationary component or between two adjacent stationary components. Clearances can be defined as a radial distance between adjacent components (e.g., a radial distance between an airfoil and a surrounding shroud), an axial distance between adjacent components (e.g., an axial distance between two stationary components), or a circumferential distance between adjacent components (e.g., between adjacent shroud segments of a shroud). Such clearances can vary or change depending on an operating condition of a gas turbine, a change in power output, a rate of change of power demanded, a health of the gas turbine, or a combination of the foregoing, among other things. Knowing or accurately estimating clearances can be useful for optimization of a gas turbine's performance and efficiency, as well as predicting and/or preventing rub events, estimating head room and time needed for restarts, determining component lifing and/or prognostic health management, and/or adjusting control of the gas turbine, among other things.

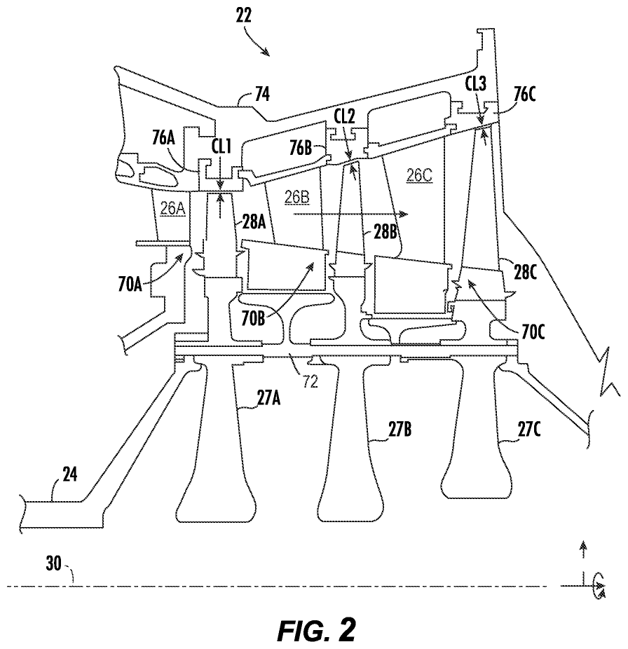

Example clearances are provided in FIG. 2, which provides a schematic cross-sectional view of the turbine section 22 of the gas turbine 10 of FIG. 1. As depicted in FIG. 2, the turbine section 22 includes a plurality of stages that each include a stationary array of stator vanes 26 and a rotating array of rotor blades 28. For instance, the turbine section 22 includes a first stage 70A having an annular array of stator vanes 26A and an annular array of rotor blades 28A, a second stage 70B having an annular array of stator vanes 26B and an annular array of rotor blades 28B, and a third stage 70C having an annular array of stator vanes 26C and an annular array of rotor blades 28C. The stator vanes 26 and airfoil portions of the rotor blades 28 extend into a hot gas path of the turbine section 22. Further, the rotor blades 28A, 28B, 28C extend radially outward from respective rotor disks 27A, 27B, 27C. Each rotor disk 27A, 27B, 27C forms a part of or is mechanically coupled to the rotor 24, and thus, each rotor disk 27A, 27B, 27C rotates about the axial centerline 30. A support arm 72 (e.g., a tie bolt) extends between and connects the rotor disks 27A, 27B, 27C.

A turbine casing 74 extends circumferentially around the turbine section 22. The turbine casing 74 can form a part of the outer casing 32 (FIG. 1). A shroud 76A circumferentially surrounds the rotor blades 28A of the first stage 70A and is coupled to the turbine casing 74. Likewise, a shroud 76B circumferentially surrounds the rotor blades 28B of the second stage 70B and is coupled to the turbine casing 74, and a shroud 76C circumferentially surrounds the rotor blades 28C of the third stage 70C and is also coupled to the turbine casing 74. The shrouds 76A, 76B, 76C can each be formed of a plurality of circumferentially arranged shroud segments.

As further shown in FIG. 2, a first clearance CL1 is defined between a tip of the rotor blades 28A and the shroud 76A, a second clearance CL2 is defined between a tip of the rotor blades 28B and the shroud 76B, and a third clearance CL3 is defined between a tip of the rotor blades 28C and the shroud 76C. Generally, the closer the tip portions of the rotor blades 28A, 28B, 28C are to their respective shrouds 76A, 76B, 76C, the better the engine performance and efficiency of the gas turbine 10. Specifically, when clearances between the tip portions and the shrouds 76A, 76B, 76C are relatively high, the high energy combustion gases can more easily escape without producing useful work. In contrast, reducing the clearances causes a larger portion of the thermal energy of the combustion gases to be converted to mechanical energy so as to provide increased output and overall efficiency.

In accordance with the inventive aspects of the present disclosure, provided herein are inventive techniques for training a reduced order model that, when trained, is operable to output estimates usable for determining clearances of a turbomachine. In addition, inventive techniques for using a trained reduced order model to output estimates are also provided. Inventive techniques for validating such estimates and clearance estimates are further provided. Such techniques can provide a number of advantages, benefits, and/or technical effects, such as providing real time or faster clearance estimates, e.g., compared to conventional methods or complex physics-based models. Knowing or accurately estimating clearances with a trained reduced order model as provided herein can be useful for a number of reasons as previously noted.

### Training A Reduced Order Model

An example manner in which a reduced order model can be trained to represent one or more other models, such as one or more complex physics-based models operable to output estimates usable for determining clearances of a gas turbine, will now be provided. When trained as provided herein, the reduced order model is operable to output estimates (e.g., bulk temperature estimates) usable for determining clearances of a turbomachine. The trained reduced order model can output estimates in real time or at reduced rates and with more accuracy compared to the one or more other models the reduced order model is trained to represent. The training techniques provided herein may apply to training a reduced order model for the gas turbine 10 of FIG. 1, other gas turbines, or more broadly, turbomachines generally.

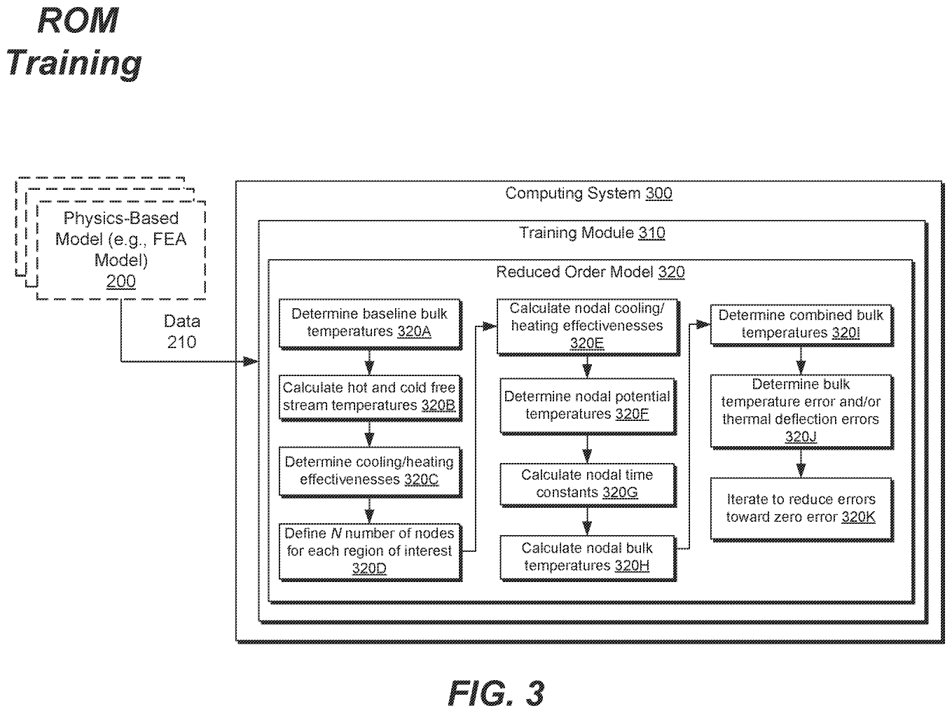

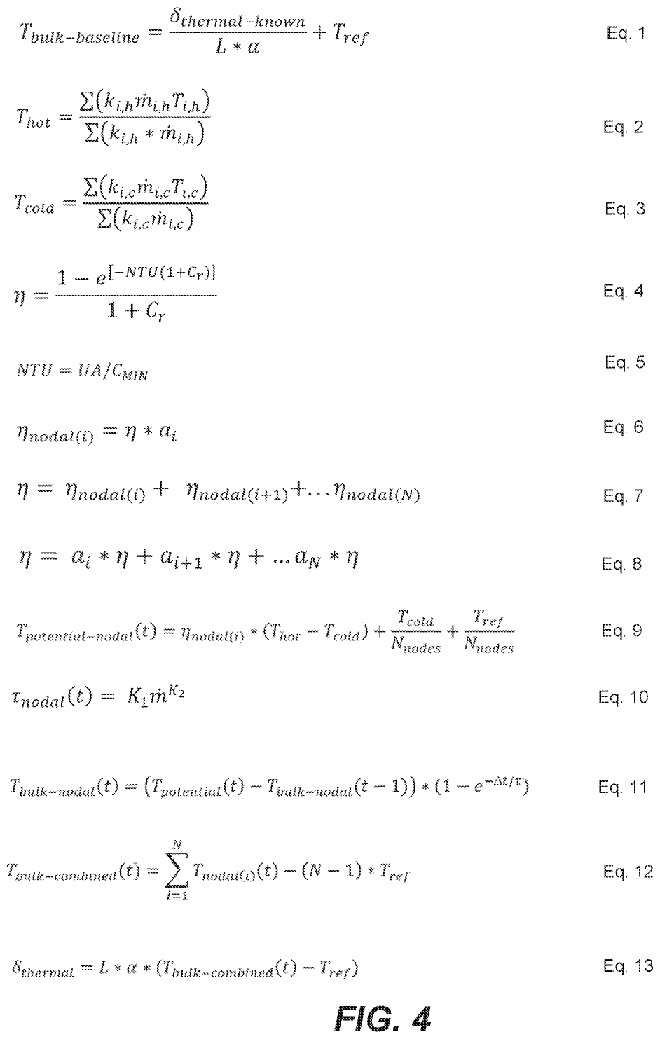

The example training process will be described below with general reference to FIGS. 3 and 4. FIG. 3 provides a data flow diagram of a reduced order model 320 being trained. FIG. 4 lists a number of equations associated with training the reduced order model. The reduced order model 320, when trained as provided herein, can be operable to output bulk temperatures for respective regions of interest of every component of interest. Such bulk temperatures can be used to determine clearances for clearances of interest of a turbomachine.

As shown in FIG. 3, a computing system 300 associated with a turbomachine, such as a gas turbine, can include a training module 310 that can be executed by one or more processors of the computing system 300 to train the reduced order model 320 to represent one or more models 200, such as one or more complex physics-based models (e.g., a Finite Element Analysis, or FEA, model). The computing system 300 can be configured as shown in FIG. 20. Data 210, such as test data or labeled training data, from or associated with the one or more models 200 can be input into the reduced order model 320. The training module 310, when executed by one or more processors of the computing system 300, can train the reduced order model 320 based on the data 210 in a recursive manner as will be explained in detail below.

Upon executing the training module 310 to commence the training process at 320A, the one or more processors can be configured to determine, for each component of interest of a turbomachine, a baseline bulk temperature for each region of interest associated with the component of interest. In some embodiments, the baseline bulk temperatures are determined based at least in part on the data received from one or more models that the reduced order model is trained to represent. In this regard, in such embodiments, the determined baseline bulk temperatures function as respective baselines upon which the reduced order model is trained. The data received from the one or more models 200 can include values for thermal deflections associated with respective regions of interest. The respective thermal deflections, or respective known thermal deflections, can be used to calculate the baseline bulk temperatures for respective predetermined regions of interest.

By way of example, with reference to FIG. 3, the baseline bulk temperatures can be determined for respective predetermined regions of interest based at least in part on respective known thermal deflections provided in the data 210 received from the one or more models 200. The one or more models 200 that the reduced order model 320 is trained to represent can be or can include a Finite Element Analysis (FEA) model and/or other physics-based models, e.g., as shown in FIG. 3.

In some embodiments, the baseline bulk temperature for a given region of interest associated with a component of interest can be calculated according to Equation 1:

$${T}_{bulk - baseline} = \frac{{δ}_{thermal - known}}{L * α} + {T}_{ref}$$

wherein T_{bulk-baseline} is a baseline bulk temperature for the given region of interest associated with the component of interest, δ_{thermal-known} is a known thermal deflection associated with the component of interest at the region of interest, L is a length of interest or dimension of the component of interest at the region of interest associated with a direction of thermal growth that affects or influences a clearance of interest, α is a linear coefficient of thermal expansion of the component of interest at the region of interest, and T_{ref} is a reference temperature.

As noted above, the known thermal deflection δₜₕₑᵣₘₐₗ used in Equation 1 can be received from one or more models 200 that the reduced order model 320 is trained to represent. The reference temperature T_{ref} can be set as desired. Particularly, the reference temperature T_{ref} can be set to a temperature from which it is desired to measure thermal growth of components, such as fifty-nine degrees Fahrenheit (59° F.) (or 15° C.), zero degrees Celsius (0° C.), etc. The same reference temperature T_{ref} is preferably used consistently throughout training of the reduced order model 320. The length of interest L can be a radial length, an axial length, or a circumferential length, for example. In some instances, the length of interest L can be a radius, e.g., of a casing or rotor.

Example components of interest of the turbomachine can include, without limitation, a casing (such as a compressor casing, a turbine casing, etc.), a rotor or shaft, a rotor disk or wheel, one or more rotating components mechanically coupled to the rotor (such as compressor blades, turbine blades, rotating disks, etc.), bearing housings, bearings, other stationary components (such as shrouds, hangers, struts, etc.), and other rotating components. A component of interest can be any component that has an effect on and/or influences a clearance between two components, or rather, a clearance of interest. For instance, the rotor, the turbine casing, the shrouds, and the rotor blades can all contribute to or influence the variability in the noted clearances CL1, CL2, CL3 in the turbine section 22 of FIG. 2. Such components can be deemed “components of interest” in determining the clearances. As a turbomachine operates at different operating points or experiences different conditions, the components of interest can influence the clearances, especially as one or more of these components can have different thermal growth rates.

A “clearance of interest” can be defined between a rotating component and a stationary component or between two stationary components. As one example, a clearance of interest can be defined between a rotating turbine blade and a stationary shroud spaced radially outward of the rotating blade. As another example, a clearance of interest can be defined between a rotating component of a seal and a stationary component of the seal. As yet another example, a clearance of interest can be defined between a first stationary member of a casing and a second stationary member of the casing.

In some embodiments, the predetermined regions of interest for a given component of interest can be defined or arranged along one or more directions. For instance, in some embodiments, the predetermined regions of interest can be arranged along an axial direction, along a radial direction, along a circumferential direction, and/or along some combination of the foregoing. In embodiments in which the predetermined regions of interest are arranged along the axial direction, the predetermined regions of interest can be predetermined axial regions of interest with each predetermined axial region of interest defined by or including a forward bound and an aft bound spaced from the forward bound along the axial direction. For instance, the predetermined axial regions of interest can correspond with stages of a compressor or stages of a turbine. For example, each stage of a turbine, which can include an array of stationary airfoils and an adjacent array of rotating airfoils, may correspond with one of the predetermined axial regions of interest. The forward bound of a given predetermined axial region of interest may be set forward of the array of stationary airfoils, and the aft bound may be set aft of the adjacent array of rotating airfoils.

In embodiments in which the predetermined regions of interest are arranged along the radial direction, the predetermined regions of interest can be predetermined radial regions of interest with each predetermined radial region of interest including an inner bound and an outer bound spaced from the inner bound along the radial direction.

In embodiments in which the predetermined regions of interest are arranged along the circumferential direction, the predetermined regions of interest can be predetermined circumferential regions of interest with each predetermined circumferential region of interest including a first bound and a second bound spaced from the first bound along the circumferential direction.

In some embodiments, baseline bulk temperatures are determined for at least two components of interest. For instance, a rotor of a turbomachine can be a first component of interest for which bulk temperatures are determined for each region of interest associated with the rotor, and a casing of the gas turbine can be a second component of interest for which bulk temperatures are determined for each region of interest associated with the casing.

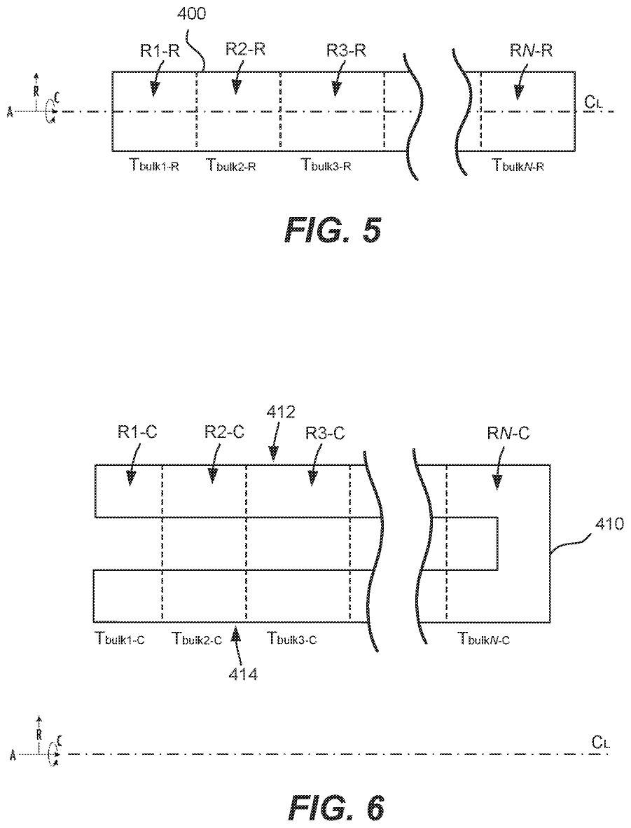

By way of example and with reference now to FIGS. 5 and 6, FIG. 5 provides a schematic view of a rotor 400 of a turbomachine depicting an example manner in which predetermined regions of interest can be defined therefor and also an example manner in which bulk temperatures can be determined for each region of interest associated with the rotor 400. FIG. 6 provides a schematic view of a casing 410 of a turbomachine depicting an example manner in which predetermined regions of interest can be defined therefor and also an example manner in which bulk temperatures can be determined for each region of interest associated with the casing 410.

As shown in FIG. 5, the predetermined regions of interest associated with the rotor 400 are arranged along the axial direction A (with the dashed lines demarcating the predetermined regions of interest). For purposes of explanation, the predetermined regions of interest are identified herein using a nomenclature of “RX-Y”, where “R” stands for “region of interest,” “X” is a numerical value, and “Y” is a letter abbreviation for the component (e.g., “R” for rotor, “C” for casing). The predetermined regions of interest associated with the rotor 400 include a first region of interest R1-R, a second region of interest R2-R disposed aft of the first region of interest R1-R, a third region of interest R3-R disposed aft of the second region of interest R2-R, and can include any suitable number of predetermined regions of interest as indicated by the Nth region of interest RN-R, wherein N is an integer greater than or equal to one (1). A bulk temperature can be determined for each predetermined regions of interest associated with the rotor 400. As shown, a first bulk temperature T_{bulk1-R} can be determined for the first region of interest R1-R, a second bulk temperature T_{bulk2-R} can be determined for the second region of interest R2-R, a third bulk temperature T_{bulk3-R} can be determined for the third region of interest R3-R, and the like, so that an Nth bulk temperature T_{bulkN-R} can be determined for the Nth region of interest RN-R.

As shown in FIG. 6, the predetermined regions of interest associated with the casing 410 are arranged along the axial direction A (with the dashed lines demarcating the predetermined regions of interest). The casing 410 can include an outer member 412 and an inner member 414 spaced from the outer member 412, e.g., along the radial direction R. The predetermined regions of interest associated with the casing 410 include a first region of interest R1-C, a second region of interest R2-C disposed aft of the first region of interest R1-C, a third region of interest R3-C disposed aft of the second region of interest R2-C, and can include any suitable number of predetermined regions of interest as indicated by the Nth region of interest RN-C, wherein N is an integer greater than or equal to one (1). A bulk temperature can be determined for each predetermined region of interest associated with the casing 410. As shown, a first bulk temperature T_{bulk1-C} can be determined for the first region of interest R1-C, a second bulk temperature T_{bulk2-C} can be determined for the second region of interest R2-C, a third bulk temperature T_{bulk3-C} can be determined for the third region of interest R3-C, and the like, so that an Nth bulk temperature T_{bulkN-C} can be determined for the Nth region of interest RN-C.

Further, in executing the training module 310 to continue the training process at 320B, the one or more processors can be configured to calculate, for each region of interest of every component of interest, a hot free stream temperature and a cold free stream temperature of fluid(s) flowing relative to the component of interest in the region of interest. Stated another way, for each component of interest, a hot free stream temperature and a cold free stream temperature of fluid(s) flowing relative thereto are calculated for each of the predetermined regions of interest of the particular component of interest. As used herein, the terms “hot” and “cold” with respect to fluid streams denote that the temperatures of the fluid steams are hot or cold relative to one another. In this regard, “hot” and “cold” are relative terms with respect to one another.

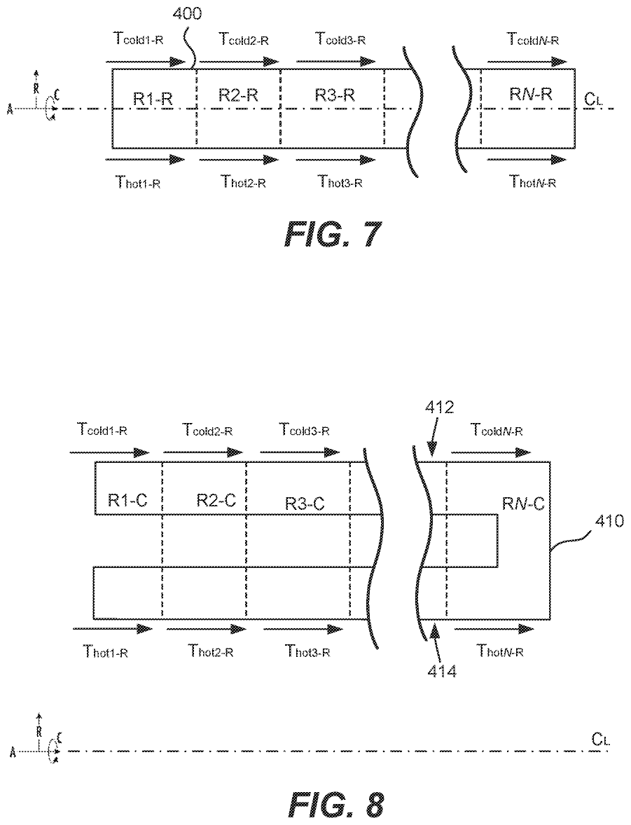

With reference to FIG. 7 and continuing with the example, a hot free stream temperature and a cold free stream temperature of fluid(s) flowing relative to the rotor 400 can be calculated for each region of interest. Particularly, a hot free stream temperature T_{hot1-R} and a cold free stream temperature T_{cold1-R} can be calculated for the first region of interest R1-R, a hot free stream temperature T_{hot2-R} and a cold free stream temperature T_{cold2-R} can be calculated for the second region of interest R2-R, a hot free stream temperature T_{hot3-R} and a cold free stream temperature T_{cold3-R} can be calculated for the third region of interest R3-R, and so on such that a hot free stream temperature T_{hotN-R} and a cold free stream temperature T_{coldN-R} can be calculated for the Nth region of interest RN-R associated with the rotor 400.

Similarly, with reference to FIG. 8 and continuing with the example, a hot free stream temperature and a cold free stream temperature of fluid(s) flowing relative to the casing 410 can be calculated for each region of interest. Particularly, a hot free stream temperature T_{hot1-C} and a cold free stream temperature T_{cold1-C} can be calculated for the first region of interest R1-C, a hot free stream temperature T_{hot2-C} and a cold free stream temperature T_{cold2-C} can be calculated for the second region of interest R2-C, a hot free stream temperature T_{hot3-C} and a cold free stream temperature T_{cold3-C} can be calculated for the third region of interest R3-C, and so on such that a hot free stream temperature T_{hotN-C} and a cold free stream temperature T_{coldN-C} can be calculated for the Nth region of interest RN-C associated with the casing 410. Subsequently, or simultaneously, the hot free stream temperature and the cold free stream temperature for a component of interest in a particular region of interest may be reduced into a single hot fluid stream temperature and a single effective cold fluid stream temperature for the component of interest in the particular region of interest.

In some embodiments, a hot free stream temperature of fluid(s) flowing relative to a component of interest in a particular region of interest can be calculated according to Equation 2:

$${T}_{hot} = \frac{\sum ( {k}_{i , h} {\dot{m}}_{i , h} {T}_{i , h} )}{\sum ( {k}_{i , h} {\dot{m}}_{i , h} )}$$

wherein Tₕₒₜ is the hot free stream temperature of fluid(s) flowing relative to a component of interest in a particular region of interest, k_{i,h} is a constant (which is determined in the training phase such that the overall error in the final bulk temperature is minimized), \dot{m}_{i,h} is a mass flow of a given one of one or more hot streams flowing relative to the component of interest in the particular region of interest, and T_{i,h} is a temperature of the given one of the one or more hot streams.

Similarly, a cold free stream temperature of fluid(s) flowing relative to a component of interest in a particular region of interest can be calculated according to Equation 3:

$${T}_{cold} = \frac{\sum ( {k}_{i , c} {\dot{m}}_{i , c} {T}_{i , c} )}{\sum ( {k}_{i , c} {\dot{m}}_{i , c} )}$$

wherein T_{cold} is the cold free stream temperature of fluid(s) flowing relative to a component of interest in a particular region of interest, k_{i,c} is a constant (which is determined in the training phase such that the overall error in the final bulk temperature is minimized), \dot{m}_{i,c} is a mass flow of a given one of one or more cold streams flowing relative to the component of interest in the particular region of interest, and T_{i,c} is a temperature of the given one of the one or more cold streams.

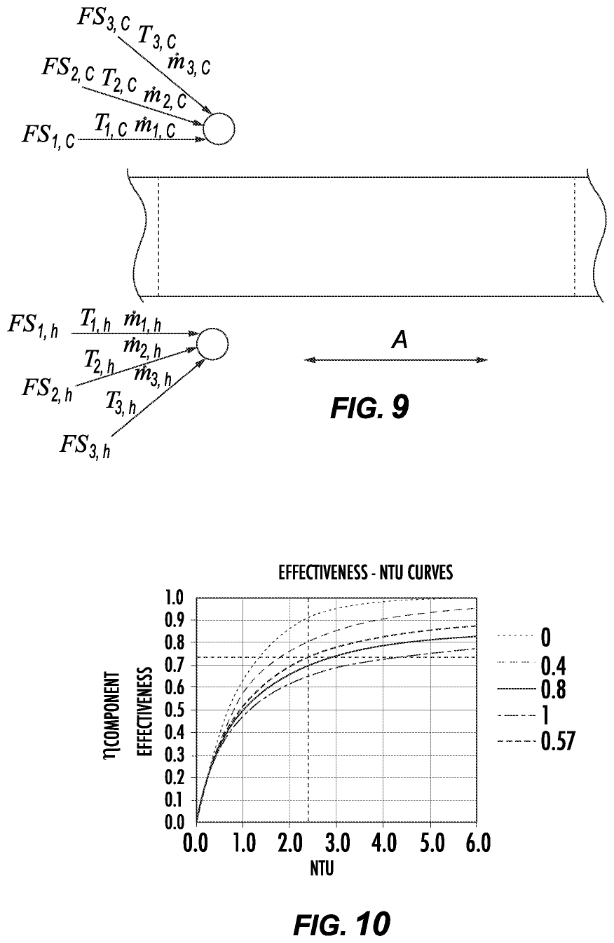

By way of example, FIG. 9 provides a schematic view of fluid streams flowing relative to a component of interest in a particular region of interest. As shown, the fluid streams include a plurality of hot free streams, including a first fluid steam FS_{1,h} having a first temperature T_{1,h} and a first mass flow \dot{m}_{1,h}, a second fluid steam FS_{2,h} having a second temperature T_{2,h} and a second mass flow \dot{m}_{2,h}, and a third fluid steam FS_{3,h} having a third temperature T_{3,h} and a third mass flow \dot{m}_{3,h}. In other embodiments, fewer or more than three hot fluid streams may be considered. To determine the hot free stream temperature Tₕₒₜ of fluid(s) flowing relative to the component of interest in the particular region of interest depicted in FIG. 9, Equation 2 may be utilized and executed as follows:

$${T}_{hot} = \frac{( {k}_{1 , h} {\dot{m}}_{1 , h} {T}_{1 , h} + {k}_{2 , h} {\dot{m}}_{2 , h} {T}_{2 , h} + {k}_{3 , h} {\dot{m}}_{3 , h} {T}_{3 , h} )}{( {k}_{1 , h} {\dot{m}}_{1 , h} + {k}_{2 , h} {\dot{m}}_{2 , h} + {k}_{3 , h} {\dot{m}}_{3 , h} )}$$

As further shown in FIG. 9, the fluid streams also include a plurality of cold free streams, including a first fluid steam FS_{1,c} having a first temperature T_{1,c} and a first mass flow \dot{m}_{1,c}, a second fluid steam FS_{2,c} having a second temperature T_{2,c} and a second mass flow \dot{m}_{2,c}, and a third fluid steam FS_{3,c} having a third temperature T_{3,c} and a third mass flow \dot{m}_{3,c}. In other embodiments, fewer or more than three cold fluid streams may be considered. To determine the cold free stream temperature T_{cold} of fluid(s) flowing relative to the component of interest in the particular region of interest depicted in FIG. 9, Equation 3 may be utilized and executed as follows:

$${T}_{cold} = \frac{( {k}_{1 , c} {\dot{m}}_{1 , c} {T}_{1 , c} + {k}_{2 , c} {\dot{m}}_{2 , c} {T}_{2 , c} + {k}_{3 , c} {\dot{m}}_{3 , c} {T}_{3 , h} )}{( {k}_{1 , h} {\dot{m}}_{1 , h} + {k}_{2 , h} {\dot{m}}_{2 , h} + {k}_{3 , h} {\dot{m}}_{3 , h} )}$$

Further, in executing the training module 310 to continue the training process at 320C (FIG. 3), the one or more processors can be configured to determine, for each region of interest of every component of interest, a cooling/heating effectiveness as a function of flow rate of fluid streams flowing relative to the component of interest in the region of interest. For instance, for the rotor 400 from the example above, a cooling/heating effectiveness η_{R} can be calculated for each region of interest R1-R, R2-R, R3-R, and so on to RN-R. Similarly, for the casing 410 from the example above, a cooling/heating effectiveness η_{c} can be calculated for each region of interest R1-C, R2-C, R3-C, and so on to RN-C. The flow rate can be measured by a flow rate measurement device, or can be estimated, e.g., by another model using measurements at another locations, or some combination of the foregoing.

As one example, a cooling/heating effectiveness can be calculated for a given region of interest of a component of interest according to Equation 4:

$$η = \frac{1 - {e}^{[ - NTU ( 1 + {C}_{r} ) ]}}{1 + {C}_{r}}$$

wherein η is the cooling/heating effectiveness for the given region of interest of a component of interest, NTU is the number of transfer units, and Cᵣ is the heat capacity ratio, which is defined as the ratio of a minimum heat capacity of the hot or cold fluid stream flowing relative the component of interest in the particular region of interest to the maximum heat capacity of the hot or cold fluid stream flowing relative the component of interest in the particular region of interest. The minimum mass flow rate of the hot fluid streams and the maximum mass flow rate of the cold fluid streams for determining the ratio Cᵣ can be derived or selected from the denominators of Equation 2 and Equation 3, respectively. That is, the minimum mass flow rate of the mass flows in the denominator of Equation 2 can be selected as the minimum mass flow rate of the hot fluid streams, and the maximum mass flow rate of the mass flows in the denominator of Equation 3 can be selected as the maximum mass flow rate of the cold fluid streams.

The number of transferred units NTU can be calculated according to Equation 5:

$$NTU = UA / {C}_{min}$$

wherein NT U is the number of transfer units, UA is an overall heat transfer rate or ability to transfer heat at the region of interest, and C_{MIN} is the minimum mass flow rate of the hot fluid streams and the cold fluid streams, which may be derived or selected from the denominator of Equation 2 or Equation 3.

With a cooling/heating effectiveness calculated, the calculated cooling/heating effectiveness can be scaled as a function of flow rate, e.g., as an average of the hot and cold fluid streams flowing relative to the component of interest in the region of interest, as a maximum flow rate of the hot and cold fluid streams, or as a minimum flow rate of the hot and cold fluid streams.

In some embodiments, as shown in FIG. 10, a calculated cooling/heating effectiveness can be scaled as a function of NTU, which is representative of a scaled mass flow rate. In some embodiments, the calculated cooling/heating effectiveness can be scaled using an iterative curve matching technique. As one example, the iterative curve matching technique can be implemented using a curve floating method in which a known curve is aligned for a best fit on average with calculated cooling/heating effectiveness(es). At each time step, the curve can be adjusted using a newly calculated cooling/heating effectiveness along with the previously calculated cooling/heating effectivenesses. As another example, the iterative curve matching technique can be implemented using an anchoring method in which a curve includes the calculated cooling/heating effectiveness (and is thus anchored) and is fit to best match measured or analytical data, e.g., received from the one or more models that the reduced order model is trained to represent.

Further, in executing the training module 310 to continue the training process at 320D (FIG. 3), the one or more processors can be configured to define N number of nodes for each region of interest, wherein N is an integer greater than or equal to one. That is, one or more nodes can be defined for each region of interest for every component of interest. Breaking down the regions of interest into nodes allows the reduced order model to output higher order responses, which may increase the accuracy of the reduced order model.

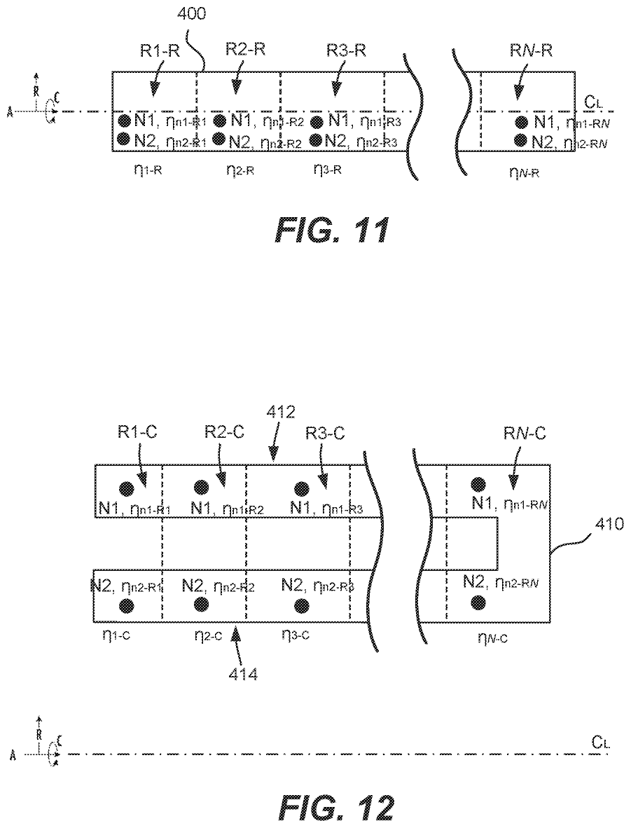

As shown in FIG. 11 and continuing with the rotor example from above, a first node N1 and a second node N2 can be defined for the first region of interest R1-R of the rotor 400, a first node N1 and a second node N2 can be defined for the second region of interest R2-R of the rotor 400, a first node N1 and a second node N2 can be defined for the third region of interest R3-R of the rotor 400, and so on such that a first node N1 and a second node N2 can be defined for the Nth region of interest RN-R of the rotor 400.

Likewise, as depicted in FIG. 12 with regard to the casing example from above, a first node N1 and a second node N2 can be defined for the first region of interest R1-C of the casing 410, a first node N1 and a second node N2 can be defined for the second region of interest R2-C of the casing 410, a first node N1 and a second node N2 can be defined for the third region of interest R3-C of the casing 410, and so on such that a first node N1 and a second node N2 can be defined for the Nth region of interest RN-C of the casing 410.

In some embodiments, more or fewer than two (2) nodes may be defined for each region of interest. Moreover, in some embodiments, a different number of nodes can be defined for different regions of interest. In other embodiments, a same number of nodes can be defined for each region of interest for the component of interest. The nodes can be superimposed or spaced from one another, such as radially, axially, and/or circumferentially.

Further, in executing the training module 310 to continue the training process at 320E (FIG. 3), the one or more processors can be configured to calculate, for each one of the nodes, a nodal cooling/heating effectiveness. The nodal cooling/heating effectiveness for a given one of the nodes is calculated as a function of the cooling/heating effectiveness associated with the given one of the nodes such that a sum of the nodal cooling/heating effectiveness for the given one of the nodes and other nodal cooling/heating effectiveness associated with the cooling/heating effectiveness is equal to the cooling/heating effectiveness.

A nodal cooling/heating effectiveness for a given node in a particular region of interest can be calculated according to Equation 6:

$${η}_{nodal ( i )} = η * {a}_{i}$$

wherein η_{nodal(i)} is the nodal cooling/heating effectiveness, η is the cooling/heating effectiveness for the region of interest that includes the node for which the nodal cooling/heating effectiveness η_{nodal(i)} is calculated, and aᵢ is an effectiveness weight for the nodal cooling/heating effectiveness η_{nodal(i)}. The effectiveness weight aᵢ can be optimized or otherwise varied over training iterations.

The cooling/heating effectiveness η for a particular region of interest can thus be written according to Equation 7:

$$η = {η}_{nodal ( i )} + * {η}_{nodal ( i + 1 )} + {…η}_{nodal ( N )}$$

wherein N is the number of nodal cooling/heating effectivenesses within the region of interest. As shown in Equation 7, the cooling/heating effectiveness η is the sum of all the nodal cooling/heating effectiveness η_{nodal(i)} for that particular region of interest. The cooling/heating effectiveness η for a particular region of interest can also be written according to Equation 8:

$$η = {a}_{i} * η + {a}_{i + 1} * η + … {a}_{N} * η$$

wherein the sum of aᵢ+aᵢ₊₁+ . . . a_{N} is equal to one (1), and wherein aᵢ*η is equal to a first nodal cooling/heating effectiveness η_{nodal(i)}, aᵢ₊₁*η is equal to a second nodal cooling/heating effectiveness η_{nodal(i+1)}, and a_{N}*η is equal to an Nth nodal cooling/heating effectiveness η_{nodal(N)}.

As illustrated in FIG. 11 and continuing with the example above, the first region of interest R1-R for the rotor 400 has a first cooling/heating effectiveness η_{1-R}. A first nodal cooling/heating effectiveness η_{n1-R1} can be calculated for the first node N1 of the first region of interest R1-R according to Equation 6 such that η_{n1-R1}=η_{1-R}*a₁, wherein a₁ is the effectiveness weight assigned to the first node N1 of the first region of interest R1-R for the particular training iteration. A second nodal cooling/heating effectiveness η_{n2-R1} can be calculated for the second node N2 of the first region of interest R1-R according to Equation 6 such that η_{n2-R1}=η_{1-R}*a₂, wherein a₂ is the effectiveness weight assigned to the second node N2 of the first region of interest R1-R for the particular training iteration. The first nodal cooling/heating effectiveness η_{n1_R1} and the second nodal cooling/heating effectiveness η_{n2-R1} are both calculated such that a sum of them is equal to the first cooling/heating effectiveness η_{1-R}, or rather so that η_{1-R}=η_{n1-R1}+η_{n2-R1} according to the Equation 7.

As further shown in FIG. 11, a first nodal cooling/heating effectiveness η_{n1-R2} can be calculated for the first node N1 of the second region of interest R2-R according to Equation 6 such that η_{n1-R2}=η_{2-R}*a₁, wherein a₁ is the effectiveness weight assigned to the first node N1 of the second region of interest R2-R for the particular training iteration. A second nodal cooling/heating effectiveness η_{n2-R2} can be calculated for the second node N2 of the second region of interest R2-R according to Equation 6 such that η_{n2-R2}=η_{2-R}*a₂, wherein a₂ is the effectiveness weight assigned to the second node N2 of the second region of interest R2-R for the particular training iteration. The first nodal cooling/heating effectiveness η_{n1-R2} and the second nodal cooling/heating effectiveness η_{n2-R2} are both calculated such that a sum of them is equal to a second cooling/heating effectiveness η_{2-R}, or rather so that η_{2-R}=η_{n1-R2}+η_{n2-R2} according to the Equation 7.

Nodal cooling/heating effectivenesses can be calculated for nodes of the third region of interest R3-R and so on for nodes up to and including the Nth region of interest RN-R. As shown in FIG. 11, first and second nodal cooling/heating effectivenesses η_{n1-R3}>η_{n2-R3} can be calculated for the first and second nodes N1, N2 of the third region of interest R3-R as a function of a third cooling/heating effectiveness η_{3-R} associated with the third region of interest R3-R. Likewise, first and second nodal cooling/heating effectivenesses η_{n1-RN}, η_{n2-RN} can be calculated for the first and second nodes N1, N2 of the Nth region of interest RN-R as a function of an Nth cooling/heating effectiveness η_{N-R} associated with the Nth region of interest RN-R.

As shown in FIG. 12, like for the rotor 400 of FIG. 11, a nodal cooling/heating effectiveness can be calculated for each node of each one of the predetermined regions of interest for the casing 410. Specifically, as depicted in FIG. 12, first and second nodal cooling/heating effectivenesses η_{n1-R1}, η_{n2-R1} can be calculated for the first and second nodes N1, N2 of the first region of interest R1-C as a function of a first cooling/heating effectiveness η_{1-C} associated with the first region of interest R1-C of the casing 410. First and second nodal cooling/heating effectivenesses η_{n1-R2}, η_{n2-R2} can be calculated for the first and second nodes N1, N2 of the second region of interest R2-C as a function of a second cooling/heating effectiveness 772-c associated with the second region of interest R2-C of the casing 410. First and second nodal cooling/heating effectivenesses η_{n1-R3}, η_{n2-R3} can be calculated for the first and second nodes N1, N2 of the third region of interest R3-C as a function of a third cooling/heating effectiveness η_{3-C} associated with the third region of interest R3-C of the casing 410. Similarly, first and second nodal cooling/heating effectivenesses η_{n1-RN}, η_{n2-RN} can be calculated for the first and second nodes N1, N2 of the Nth region of interest RN-C as a function of an Nth cooling/heating effectiveness η_{N-C} associated with the Nth region of interest RN-C of the casing 410. It should be noted that, although the nodal cooling/heating effectivenesses for the rotor and the casing are identified with the same nomenclature (e.g., η_{n1-R1}), the values may vary due to the regional conditions in the respective component of interest (e.g., rotor vs. casing).

Further, in executing the training module 310 to continue the training process at 320F (FIG. 3), the one or more processors can be configured to determine, for each one of the nodes, a nodal potential temperature, the nodal potential temperature for a given one of the nodes being determined based at least in part on the nodal cooling/heating effectiveness associated with the given one of the nodes. Stated differently, nodal potential temperatures are determined for respective nodes based at least in part on their respective cooling/heating effectivenesses. A nodal potential temperature is a temperature that a component of interest could reach at a node given the present conditions are held constant and experienced for a sufficient time.

In some embodiments, a nodal potential temperature for a given node can be calculated according to Equation 9:

$${T}_{potential - nodal} ( t ) = {η}_{nodal ( i )} * ( {T}_{hot} - {T}_{cold} ) + \frac{{T}_{cold}}{{N}_{nodes}} + \frac{{T}_{ref}}{{N}_{nodes}}$$

wherein T_{potential-nodal}(t) is the nodal potential temperature for the given node at a given time point, η_{nodal}(i) is the nodal cooling/heating effectiveness for the given node, Tₕₒₜ is the hot free stream temperature of fluid(s) flowing relative to the component of interest in the region of interest associated with the given node, T_{cold} is the cold free stream temperature of fluid(s) flowing relative to the component of interest in the region of interest associated with the given node, N_{nodes} is a number of nodes within the region of interest associated with the given node, and T_{ref} is a reference temperature that was used previously.

As one example, the nodal potential temperature for the first node N1 of the first region of interest R1-R of the rotor 400 of FIG. 11 can be calculated according to Equation 9 as follows:

$${T}_{potential - n 1 - R 1} ( t ) = {η}_{n 1 - R 1} * ( {T}_{hot 1 - R} - {T}_{cold 1 - R} ) + \frac{{T}_{cold 1 - R}}{{N}_{nodes}} + \frac{{T}_{ref}}{{N}_{nodes}}$$

wherein T_{potential-n1-R1}(t) is the nodal potential temperature for the first node N1 of the first region of interest R1-R of the rotor 400 at a given time point, η_{n1-R1} is the first nodal cooling/heating effectiveness for the first node N1 of the first region of interest R1-R of the rotor 400, T_{hot1-R} is the hot free stream temperature of fluid(s) flowing relative to the rotor 400 in the first region of interest R1-R (as shown in FIG. 7), T_{cold1-R} is the cold free stream temperature of fluid(s) flowing relative to the rotor 400 in the first region of interest R1-R, N_{nodes} is the number of nodes within the first region of interest R1-R associated with the first node N1 of the first region of interest R1-R of the rotor 400, which in this example is two (2) nodes, and T_{ref} is the reference temperature that was used previously. It will be appreciated that nodal potential temperatures for the other nodes associated with the rotor 400 and the nodes associated with the casing 410 (FIG. 12) can be calculated using Equation 9 in a similar manner as described above.

Further, in executing the training module 310 to continue the training process at 320G (FIG. 3), the one or more processors can be configured to calculate, for each one of the nodes, a nodal time constant as a function of flow rate, e.g., using a lump capacitance method. In some embodiments, for instance, a nodal time constant for a given node at a given time point can be calculated according to Equation 10:

$${τ}_{nodal} ( t ) = {K}_{1} {\dot{m}}^{{K}_{2}}$$

wherein τ_{nodal(t)} is the nodal time constant for the given node at the given time point, K₁ is a first constant, \dot{m} is a mass flow at the given node at the given time point, and K₂ is a second constant. The first constant K₁ can be the same or different than the second constant K₂.

For every node of interest in every region of interest the lumped capacitance model is applied. The lumped capacitance model is an approach used to analyze transient heat transfer in solid objects. The key assumption of the lumped capacitance model is that the solid object may be treated as a single “lump” with a negligible temperature gradient throughout its volume at any given instance. The lumped capacitance method is approximate for calculating transient solid temperatures in the presence of heat convecting mediums, but becomes more accurate as the ratio temperature drop in the solid is small relative to the temperature difference between the solid surface and convecting fluid. In order to improve accuracy, the node count can be increased; and to improve calculation speed, the node count can be reduced.

Further, in executing the training module 310 to continue the training process at 320H (FIG. 3), the one or more processors can be configured to calculate, for each one of the nodes, a nodal bulk temperature, the nodal bulk temperature for a given one of the nodes being calculated based at least in part on the nodal time constant, the nodal potential temperature, and a previous nodal bulk temperature each associated with the given one of the nodes. Stated differently, nodal bulk temperatures are determined for respective nodes based at least in part on their respective nodal time constants, nodal potential temperatures, and previous nodal bulk temperatures.

In some embodiments, for instance, a nodal bulk temperature for a given node can be calculated according to Equation 11:

$${T}_{bulk - nodal} ( t ) = ( {T}_{potential} ( t ) - {T}_{bulk - nodal} ( t - 1 ) ) * ( 1 - {e}^{- Δ t / τ} )$$

wherein T_{bulk-nodal}(t) is the nodal bulk temperature for the given node at a given time point, Tₚₒₜₑₙₜᵢₐₗ(t) is the nodal potential temperature for the given node at the given time point, T_{bulk-nodal}(t−1) is the nodal bulk temperature for the given node at a previous time point, Δt is a time difference between the current time point and the previous time point, and τ is the nodal time constant for the given node at the given time point.

As one example, for a given time point, a nodal bulk temperature for the first node N1 of the first region of interest R1-R of the rotor 400 of FIG. 11 can be calculated according to Equation 11 as follows:

$${T}_{bulk - n 1 - R 1} ( t ) = ( {T}_{potential - n 1 - R 1} ( t ) - {T}_{bulk - n 1 - R 1} ( t - 1 ) ) * ( 1 - {e}^{- Δ t / τ} )$$

wherein T_{bulk-n1-R1}(t) is a first nodal bulk temperature for the first node N1 of the first region of interest R1-R of the rotor 400 at the given time point, T_{potential-n1-R1}(t) is the nodal potential temperature for the first node N1 of the first region of interest R1-R of the rotor 400 at the given time point, T_{bulk-n1-R1}(t−1) is the first nodal bulk temperature for the first node N1 of the first region of interest R1-R of the rotor 400 at the previous time point, Δt is the time difference between the current or given time point (t) and the previous time point (t−1), and τ is the nodal time constant associated with the first node N1 at the given time point (t). It will be appreciated that nodal bulk temperatures for the other nodes associated with the rotor 400 and the nodes associated with the casing 410 (FIG. 12) can be calculated using Equation 11 in a similar manner as described above.

Further, in executing the training module 310 to continue the training process at 320I (FIG. 3), the one or more processors can be configured to combine, for each one of the regions of interest, the nodal bulk temperatures associated with the nodes of a given one of the regions of interest into a combined bulk temperature. That is, combined bulk temperatures are determined for respective regions of interest. The bulk temperature for a given region of interest is determined by combining the nodal bulk temperatures within the given region of interest.

In some embodiments, a combined bulk temperature for a given region of interest can be calculated according to Equation 12:

$${T}_{bulk - combined} ( t ) = {\sum }_{i = 1}^{N} {T}_{nodal ( i )} ( t ) - ( N - 1 ) * {T}_{ref}$$

wherein T_{bulk-combined}(t) is the combined bulk temperature for the given region of interest at a given time point, Σᵢ₌₁^{N} T_{nodal(i)}(t) is the sum of the nodal bulk temperatures associated with the region of interest for the given time point, N is the number of nodes defined or associated with the region of interest, and T_{ref} is the reference temperature that was used previously.

As one example, for a given time point, a combined bulk temperature for the first region of interest R1-R of the rotor 400 of FIG. 11 can be calculated according to Equation 12 as follows:

$${T}_{bulk - combined - R 1 - R} ( t ) = ( {T}_{bulk - n 1 - R 1} ( t ) + {T}_{bulk - n 2 - R 1} ( t ) ) - ( N - 1 ) * {T}_{ref}$$

wherein T_{bulk-combined-R1-R}(t) is the combined bulk temperature for the first region of interest R1-R of the rotor 400, T_{bulk-n1_R1}(t) is a first nodal bulk temperature for the first node N1 of the first region of interest R1-R of the rotor 400 at the given time point, T_{bulk-n2-R1}(t) is a second nodal bulk temperature for the second node N2 of the first region of interest R1-R of the rotor 400 at the given time point, N is the number of nodes defined or associated with the first region of interest R1-R of the rotor 400, which in this example is two (2) nodes, and T_{ref} is the reference temperature that was used previously. It will be appreciated that combined bulk temperatures for the other regions of interest associated with the rotor 400 and the regions of interest associated with the casing 410 (FIG. 12) can be calculated using Equation 12 in a similar manner as described above.

Further, in executing the training module 310 to continue the training process at 320J (FIG. 3), the one or more processors can be configured to determine, for each one of the regions of interest, respective bulk temperature errors and/or respective thermal deflection errors based at least in part on respective ones of the combined bulk temperatures. In some embodiments, determining, for each one of the regions of interest, the respective bulk temperature errors and/or respective thermal deflection errors includes performing one or more both of: (1) (A) converting each one of the combined bulk temperatures into respective thermal deflections; (B) comparing the respective thermal deflections to respective known thermal deflections; and (C) determining respective thermal deflection errors based at least in part on the comparing; and/or (2) (A) comparing respective ones of the combined bulk temperatures to respective baseline bulk temperatures; and (B) determining respective bulk temperature errors based at least in part on the comparing of the respective ones of the combined bulk temperatures to the respective baseline bulk temperatures.

For (1) at 320J, the combined bulk temperatures can be converted into respective thermal deflections, the thermal deflections can then be compared to respective known thermal deflections, which may be received from the one or more models that the reduced order model is trained to represent, and respective thermal deflection errors can be determined for the regions of interest based at least in part on the respective comparisons. As one example, a given combined bulk temperature can be converted into a thermal deflection according to Equation 13 as follows:

$${δ}_{thermal} = L * α * ( {T}_{bulk - combined} ( t ) - {T}_{ref} )$$

wherein δₜₕₑᵣₘₐₗ is a thermal deflection associated with the component of interest at the region of interest, L is a length of interest or dimension of the component of interest at the region of interest associated with a direction of thermal growth that affects or influences a clearance of interest, α is a linear coefficient of thermal expansion of the component of interest at the region of interest, T_{bulk-combined}(t) is the combined bulk temperature for the given region of interest at a given time point, and T_{ref} is the reference temperature previously utilized. With the thermal deflection δₜₕₑᵣₘₐₗ determined for the region of interest, the thermal deflection δₜₕₑᵣₘₐₗ can be compared to a known thermal deflection δₜₕₑᵣₘₐₗ-known, e.g., by subtracting the thermal deflection δₜₕₑᵣₘₐₗ from the known thermal deflection δ_{thermal-known} or vice versa. The difference between the thermal deflection δₜₕₑᵣₘₐₗ and the known thermal deflection δ_{thermal-known} can be defined as the thermal deflection error for the given region of interest. The thermal deflection error essentially characterizes how accurately the reduced order model represents or models the one or more models that the reduced order model is trained to represent.

As one example, for a given time point, a thermal deflection for the first region of interest R1-R of the rotor 400 of FIG. 11 can be converted from the combined bulk temperature T_{bulk-combined-R1-R}(t) according to Equation 13 as follows:

$${δ}_{thermal - R 1 - R} = L * α * ( {T}_{bulk - combined - R 1 - R} ( t ) - {T}_{ref} )$$

wherein δ_{thermal-R1-R} is the thermal deflection for the first region of interest R1-R of the rotor 400, L is a length of interest or dimension of the rotor 400 (e.g., a radius of the rotor 400) at the first region of interest R1-R associated with a direction of thermal growth that affects or influences a clearance of interest (e.g., a distance between a rotor blade and a radially outward shroud), α is a linear coefficient of thermal expansion of the rotor 400 at the first region of interest R1-R, T_{bulk-combined-R1-R}(t) is the combined bulk temperature for the first region of interest R1-R at the given time point, and T_{ref} is the reference temperature that was used previously.

With the thermal deflection δ_{thermal-R1-R} determined or converted from the combined bulk temperature T_{bulk-combined-R1-R}(t), the thermal deflection δ_{thermal-R1-R} associated with the first region of interest R1-R of the rotor 400 is compared to a known thermal deflection δ_{thermal-known-R1-R} associated with the first region of interest R1-R of the rotor 400. For instance, the thermal deflection δ_{thermal-R1-R} can be subtracted from the known thermal deflection δ_{thermal-known-R-R1-R}, or vice versa. The difference between the thermal deflection δ_{thermal-R1-R} and the known thermal deflection δ_{thermal-known-R1-R} can be defined as a thermal deflection error Δ_{δ-R1-R} for the first region of interest R1-R for the rotor 400. It will be appreciated that thermal deflection errors for the other regions of interest associated with the rotor 400 and the regions of interest associated with the casing 410 (FIG. 12) can be calculated using Equation 13 in a similar manner as described above.

For (2) at 320J, in addition or alternatively to performing approach (1), the combined bulk temperatures can be compared to respective baseline bulk temperatures, which may be determined as described above or provided by the one or more models that the reduced order model is trained to represent, and respective bulk temperature errors can be determined for the regions of interest based at least in part on the respective comparisons.

As one example, the combined bulk temperature T_{bulk-combined-R1-R}(t) associated with the first region of interest R1-R of the rotor 400 (calculated using Equation 12) can be compared to a known bulk temperature, which in this example is the first bulk temperature T_{bulk1-R} determined for the first region of interest R1-R (FIG. 5). For instance, for the comparison, the combined bulk temperature T_{bulk-combined-R1-R}(t) can be subtracted from the first bulk temperature T_{bulk1-R}, or vice versa. The difference between the combined bulk temperature T_{bulk-combined-R-R}(t) and the first bulk temperature T_{bulk1-R} can be defined as a bulk temperature error Δ_{Tbulk-R1-R} for the first region of interest R1-R for the rotor 400. It will be appreciated that bulk temperature errors for the other regions of interest associated with the rotor 400 and the regions of interest associated with the casing 410 (FIG. 12) can be calculated in a similar manner as described above.

Further, in executing the training module 310 to continue the training process at 320K (FIG. 3), the one or more processors can be configured to iteratively implement an optimization routine to reduce the respective thermal deflection errors and/or the respective bulk temperature errors toward zero error by adjusting one or more tuning parameters. Stated differently, the above-described training operations 320A through 320J are iterated to reduce the thermal deflection errors and/or the bulk temperature errors toward zero error by adjusting one or more tuning parameters.

In some embodiments, the training operations can be iterated until one or more conditions are satisfied. For instance, the training operations can be iterated until, e.g., the thermal deflection errors and/or the bulk temperature errors are reduced within a predetermined error margin of a threshold number (e.g., zero), the thermal deflection errors and/or the bulk temperature errors are reduced to a predetermined error threshold (e.g., to 2% error), etc. In some embodiments, the training operations can be iterated a predetermined number of iterations (e.g., 10,000 iterations). Other conditions are also possible.

Example tuning parameters include, but are not limited to effectiveness weights aᵢ (as utilized in Equations 6 and/or 8), the first and/or second constants K₁, K₂ for determining a nodal time constant (as utilized in Equation 10), the flow weight constants k_{i,h} and/or k_{i,c} (as utilized in Equations 2 and/or 3), a combination of the foregoing, etc. One or more of the tuning parameters can be tuned to reduce the thermal deflection errors and/or the bulk temperature errors toward zero error.

Once the thermal deflection errors and/or the bulk temperature errors are reduced to, e.g., a predetermined error threshold, the reduced order model 320 can be deemed trained. The reduced order model 320 can be retrained as described above based on new training data, e.g., at predetermined time intervals and/or upon a trigger condition. As will be explained in more detail further herein, the trained reduced order model can receive new data or non-training data and can output estimates usable for determining clearances of a turbomachine based on the received data.

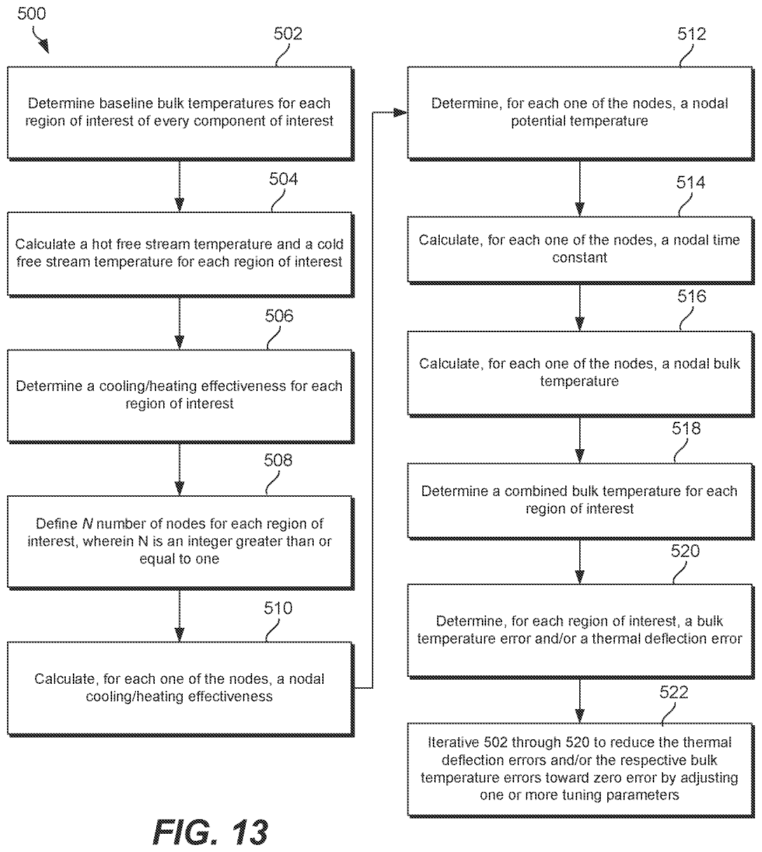

FIG. 13 provides a flow diagram for a method 500 of training a reduced order model, which when trained, is operable to output estimates usable for determining clearances of a turbomachine, such as a gas turbine. The method 500 is provided by way of example, and in alternative implementations, operations of the method 500 can be modified, adapted, expanded, rearranged and/or omitted in various ways without deviating from the scope of the present subject matter.

At 502, the method 500 includes determining, for each component of interest of a turbomachine, a baseline bulk temperature for each region of interest associated with the component of interest. In some implementations, at 502, the baseline bulk temperature for a given region of interest associated with a component of interest can be calculated according to Equation 1.

At 504, the method 500 includes calculating, for each region of interest of every component of interest, a hot free stream temperature and a cold free stream temperature of fluid(s) flowing relative to the component of interest in the region of interest. Stated another way, for each component of interest, a hot free stream temperature and a cold free stream temperature of fluid(s) flowing relative thereto are calculated for each of the predetermined regions of interest of the particular component of interest. In some implementations, at 504, the hot free stream temperature and the cold free stream temperature of fluid(s) flowing relative to a component of interest in a region of interest can be calculated according to Equations 2 and 3, respectively.

At 506, the method 500 includes determining, for each region of interest of every component of interest, a cooling/heating effectiveness as a function of flow rate of fluid streams flowing relative to the component of interest in the region of interest. In some implementations, at 506, the cooling/heating effectivenesses can be determined according to Equations 4 and 5.

At 508, the method 500 includes defining N number of nodes for each region of interest, wherein N is an integer greater than or equal to one. That is, one or more nodes can be defined for each region of interest for every component of interest.

At 510, the method 500 includes calculating, for each one of the nodes, a nodal cooling/heating effectiveness. The nodal cooling/heating effectiveness for a given one of the nodes is calculated as a function of the cooling/heating effectiveness associated with the given one of the nodes such that a sum of the nodal cooling/heating effectiveness for the given one of the nodes and other nodal cooling/heating effectiveness associated with the cooling/heating effectiveness is equal to the cooling/heating effectiveness. In some implementations, at 510, the nodal cooling/heating effectivenesses can be determined according to Equation 6.

At 512, the method 500 includes determining, for each one of the nodes, a nodal potential temperature, the nodal potential temperature for a given one of the nodes being determined based at least in part on the nodal cooling/heating effectiveness associated with the given one of the nodes. Stated differently, nodal potential temperatures are determined for respective nodes based at least in part on their respective cooling/heating effectivenesses. In some implementations, at 512, the nodal potential temperature for a given node can be determined according to Equation 9.

At 514, the method 500 includes calculating, for each one of the nodes, a nodal time constant as a function of flow rate, e.g., using a lump capacitance method. In some implementations, at 514, a nodal time constant for a given node can be determined according to Equation 10.

At 516, the method 500 includes calculating, for each one of the nodes, a nodal bulk temperature, the nodal bulk temperature for a given one of the nodes being calculated based at least in part on the nodal time constant, the nodal potential temperature, and a previous nodal bulk temperature each associated with the given one of the nodes. Stated differently, nodal bulk temperatures are determined for respective nodes based at least in part on their respective nodal time constants, nodal potential temperatures, and previous nodal bulk temperatures. In some implementations, at 516, a nodal bulk temperature for a given node can be determined according to Equation 11.

At 518, the method 500 includes combining, for each one of the regions of interest, the nodal bulk temperatures associated with the nodes of a given one of the regions of interest into a combined bulk temperature. That is, combined bulk temperatures are determined for respective regions of interest. The bulk temperature for a given region of interest is determined by combining the nodal bulk temperatures within the given region of interest. In some implementations, at 518, a combined bulk temperature for a given region of interest can be determined according to Equation 12.

At 520, the method 500 includes determining, for each one of the regions of interest, respective bulk temperature errors and/or respective thermal deflection errors based at least in part on respective ones of the combined bulk temperatures. In some implementations, determining, for each one of the regions of interest, the respective bulk temperature errors and/or respective thermal deflection errors at 520 includes performing one or more both of: (1) (A) converting each one of the combined bulk temperatures into respective thermal deflections; (B) comparing the respective thermal deflections to respective known thermal deflections; and (C) determining respective thermal deflection errors based at least in part on the comparing; and/or (2) (A) comparing respective ones of the combined bulk temperatures to respective baseline bulk temperatures; and (B) determining respective bulk temperature errors based at least in part on the comparing of the respective ones of the combined bulk temperatures to the respective baseline bulk temperatures. In some implementations, a given combined bulk temperature can be converted into a thermal deflection using Equation 13.

At 522, the method 500 includes iteratively implementing an optimization routine to reduce the respective thermal deflection errors and/or the respective bulk temperature errors toward zero error by adjusting one or more tuning parameters. Stated differently, the method 500 (training operations 502 through 520) are iterated to reduce the thermal deflection errors and/or the bulk temperature errors determined at 520 toward zero error by adjusting one or more tuning parameters.

### Using/Validating the Reduced Order Model

An example manner in which a reduced order model (e.g., reduced order model 320) trained as provided herein can be used to output estimates (e.g., estimated bulk temperatures for each region of interest of every component of interest) usable for determining clearances of a turbomachine will now be provided. A reduced order model trained as provided herein (hereinafter “reduced order model 320T”) can be utilized to output estimates that can be used to determine clearances for the gas turbine 10 of FIG. 1, for example, as well as for other gas turbines, or more broadly, for turbomachines generally. Aspects relating to validation of the reduced order model will also be provided.

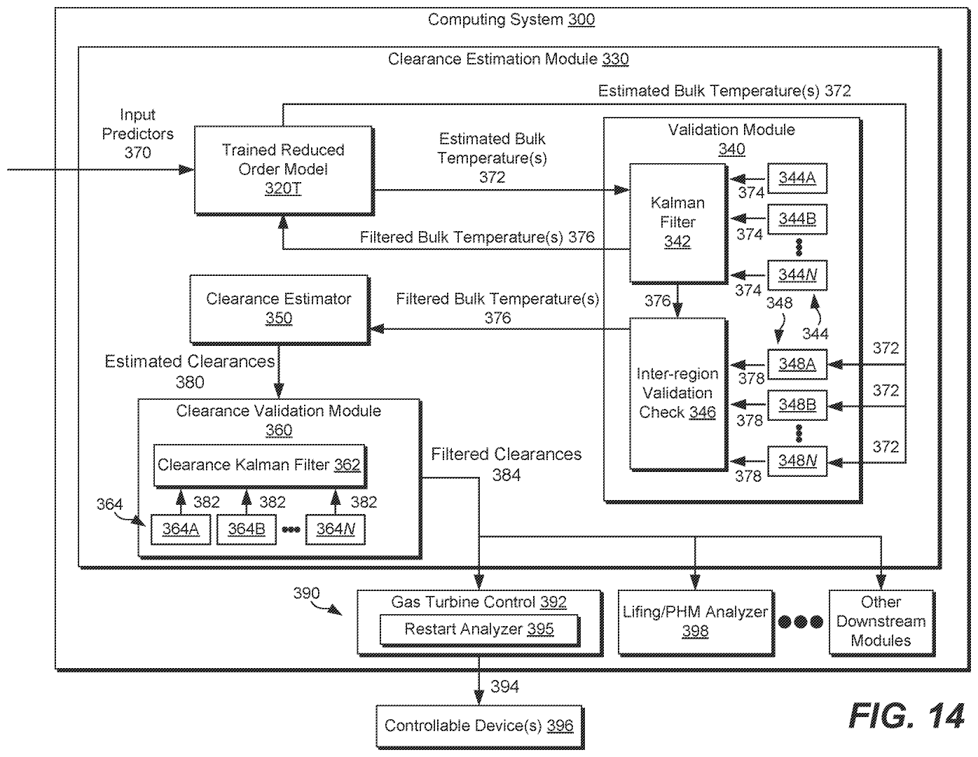

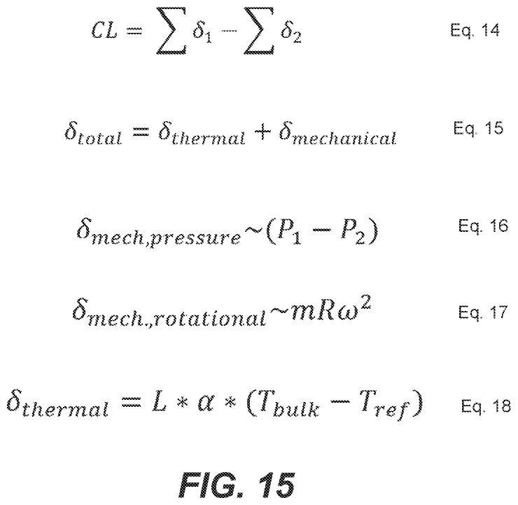

With general reference now to FIGS. 14 and 15, FIG. 14 provides a data flow diagram for using a reduced order model trained to output estimates that can be used to determine clearances for a turbomachine. FIG. 15 lists a number of equations associated with using a trained reduced order model to output estimates that can be used to determine clearances for a turbomachine.

As shown in FIG. 14, the computing system 300 associated with a turbomachine can include a clearance estimation module 330 for estimating clearances of a turbomachine. That is, when one or more processors of the computing system 300 execute the clearance estimation module 330, the one or more processors can output one or more clearances of a turbomachine. For instance, the one or more processors can execute the clearance estimation module 330 to determine and output clearances for a plurality of stages of a compressor and/or turbine section of a gas turbine.

The clearance estimation module 330 can include a trained reduced order model 320T, which has been trained (e.g., in accordance with the method 500 of FIG. 13) to represent one or more models, such as one or more physics-based models. One or more input predictors 370 can be input into the trained reduced order model 320T and, based at least in part on the one or more input predictors 370, the trained reduced order model 320T can output one or more estimates, such as estimated bulk temperatures 372 for each region of interest of every component of interest of a turbomachine. By way of example, a rotor and a casing of a gas turbine can be components of interest, and accordingly, the trained reduced order model 320T can output an estimated bulk temperature for each region of interest of the rotor and an estimated bulk temperature for each region of interest of the casing.

Example input predictors can include, without limitation, a compressor inlet temperature, a compressor discharge temperature, an ambient temperature, a turbine exhaust temperature, a compressor discharge pressure, an ambient pressure, an engine speed, an inlet guide vane position, a combination of the foregoing, etc. Such input predictors can be sensed input predictors. Further, other example input predictors include, without limitation, a compressor core flow, a turbine inlet flow, a turbine inlet temperature, a combustion temperature (flame), a combination of the foregoing, etc. Such input predictors can be virtual input predictors derived from one or more sensed inputs.

The clearance estimation module 330 can optionally include a validation module 340. As depicted in FIG. 14, the validation module 340 can include a Kalman filter 342, such as an unscented Kalman filter, and one or more measurement models 344. The measurement models 344 can each provide measured bulk temperatures 374 for regions of interest of respective components of interest. In some embodiments, the measurement models 344 can include at least one measurement model for every component of interest, with each measurement model being associated with a given one of the components of interest and being configured to provide measured bulk temperatures for the regions of interest of the given component of interest.

For instance, the measurement models 344 can include a rotor measurement model 344A configured to estimate or provide measured bulk temperatures for the regions of interest of a rotor of a gas turbine, a casing measurement model 344B configured to estimate or provide measured bulk temperatures for the regions of interest of a casing of the gas turbine, and so on for each component of interest as represented by an Nth measurement model 344N, wherein N is an integer greater than or equal to one or a letter that comes after “B” alphabetically. The measurement models 344 estimate or provide their respective measured bulk temperatures 374 independent of inputs from the trained reduced order model 320T or without consideration of the estimated bulk temperatures 372 output from the trained reduced order model 320T. In this regard, the measurement models 344 can output their respective measured bulk temperatures 374 independent of the trained reduced order model 320T. The measurement models 344 can output their respective measured bulk temperatures 374 based on, e.g., measurements from one or more thermocouples or clearance probes of a gas turbine. The measured bulk temperatures 374 can be routed to the Kalman filter 342 as illustrated in FIG. 14.

The Kalman filter 342 receives the estimated bulk temperatures 372 from the trained reduced order model 320T as well as the measured bulk temperatures 374 from the one or more measurement models 344. Additionally, as part of the training process, an error covariance matrix is created for both the reduced order models and the measurement models for all components of interest in all regions of interest. The Kalman filter 342 can produce a conditional bulk temperature distribution (e.g., a bell curve) for each region of interest for every component of interest. For instance, an estimated bulk temperature distribution and a measured bulk temperature distribution can be generated for each region of interest of a rotor of a gas turbine and an estimated bulk temperature distribution and a measured bulk temperature distribution can be generated for each region of interest of a casing of the gas turbine. For a given region of interest, the estimated bulk temperature distribution is generated based at least in part on the estimated bulk temperature 372 associated with the given region of interest and the measured bulk temperature distribution is generated based at least in part on the measured bulk temperature 374 associated with the given region of interest. The shapes of a given distribution represents the uncertainty in each of the given distributions, with more certain estimates being represented by sharper (narrower) bell curves and less certain estimates being represented by less sharp (wider) curves.

Based at least in part of the estimated bulk temperature distribution and the measured bulk temperature distribution for a given region of interest of a component of interest, a filtered bulk temperature 376 for the given region of interest can be determined. For instance, the Kalman filter 342 can generate a conditional distribution for a given region of interest of a component of interest based at least in part on the expected value of the estimated bulk temperature and the expected value of the measured bulk temperature associated with the given region of interest. The filtered bulk temperature 376 can be selected as the most likely outcome or temperature of the conditional distribution, for example. Accordingly, the Kalman filter 342 can output filtered bulk temperatures 376 for each region of interest for each component of interest, with each filtered bulk temperature 376 representing the most likely outcome of its associated conditional distribution. In some embodiments, the estimated and measured bulk temperature distributions 372, 374 can be weighted, and the conditional distribution can be generated according to weights assigned to the estimated and measured bulk temperature distributions 372, 374.

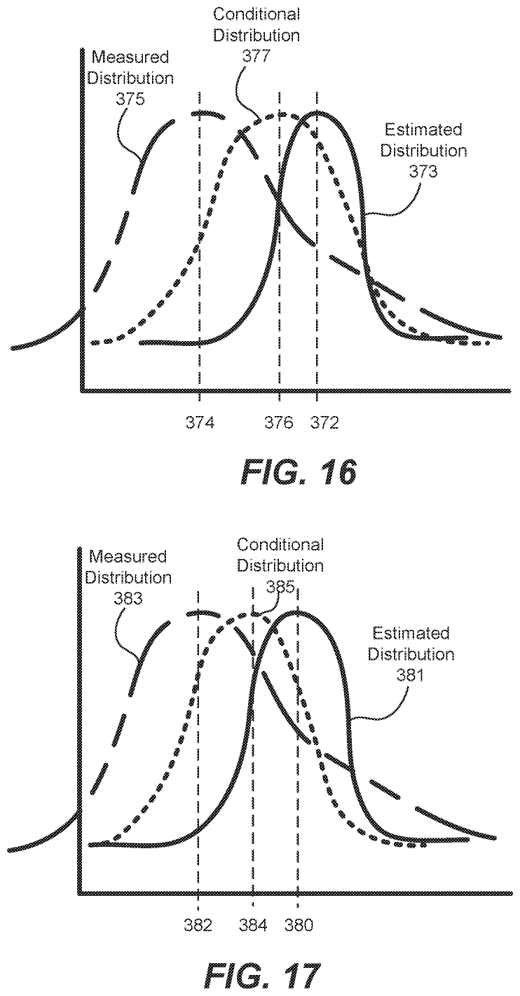

FIG. 16 provides example distributions for a given region of interest of a component of interest. The x-axis may be the error between the reduced order model and the measured values (i.e., reality), and the y-axis may be the probability density function. As depicted in FIG. 16, the Kalman filter 342 (FIG. 14) can generate an estimated bulk temperature distribution 373 based on the expected value of the estimated bulk temperature 372 associated with the given region of interest and a measured bulk temperature distribution 375 based on the expected value of the measured bulk temperature 374 and the respective error covariance matrices. From these two distribution curves, a conditional distribution 377 can be generated (i.e., the Posterior Distribution). Based on the posterior distribution 377 curve, the most likely value for the true bulk temperature 376 can be determined as well as the uncertainty in the true bulk temperature. Notably, the shape of the curves in FIG. 16 are intended to serve as examples and are not intended to be limiting. The actual distributions may have any suitable shape and this disclosure should not be limited to the shapes shown in FIG. 16 unless specifically recited in the claims.

Returning to FIGS. 14 and 15, the filtered bulk temperatures 376 can be output from the Kalman filter 342 and. e.g., routed to the trained reduced order model 320T to be used for the next time point. In addition, optionally, the validation module 340 can include an inter-region validation check 346 to which the filtered bulk temperatures 376 can be routed. Generally, the inter-region validation check 346 checks the filtered bulk temperatures 376 against weighted inter-region bulk temperatures 378 received from respective health models 348. The inter-region validation check 346 functions to ensure that the filtered bulk temperatures 376 are consistent from region of interest to region of interest.

Particularly, as shown in FIG. 14, the validation module 340 can include the one or more health models 348 that each provide weighted bulk temperatures 378 to the inter-region validation check 346. Each health model 348 can be associated with one of the components of interest. For instance, the health models 348 can include a rotor health model 348A configured to provide weighted inter-region bulk temperatures for the regions of interest of a rotor of a gas turbine, a casing measurement model 348B configured to provide weighted inter-region bulk temperatures for the regions of interest of a casing of the gas turbine, and so on for each component of interest as represented by an Nth health model 348N. The health models 348 receive the estimated bulk temperatures 372 output from the trained reduced order model 320T and use the estimated bulk temperatures 372 from multiple regions of interest to determine the weighted bulk temperatures 378.

A given one of the weighted bulk temperatures 378 can be determined for a given region of interest of a component of interest by taking an average of an estimated bulk temperature of a region of interest forward or upstream of the given region of interest (such as the region of interest immediately forward of the given region of interest) and an estimated bulk temperature of a region of interest aft or downstream of the given region of interest (such as the region of interest immediately aft of the given region of interest). For example, a weighted bulk temperature for a region of interest corresponding to stage i of a compressor or turbine can be determined by taking an average of the estimated bulk temperature of a stage forward of stage i, such as stage i−1, and the estimated bulk temperature of a stage aft of stage i, such as stage i+1. Thus, the weighted bulk temperature for stage i takes into account the estimated bulk temperatures of the stages forward and aft of the stage i.

The weighted bulk temperatures 378 can be routed to the inter-region validation check 346 for comparison with respective filtered bulk temperatures 376. For instance, a filtered bulk temperature 376 associated with a given region of interest of a component of interest can be compared to a weighted bulk temperature 378 associated with the given region of interest. In some embodiments, a predetermined range can be determined or assigned to the weighted bulk temperature 378, and it can be determined whether the filtered bulk temperature 376 associated with the given region of interest is within the predetermined range. Such a determination can ensure that the filtered bulk temperature 376 “makes sense” given the estimated bulk temperatures of regions of interest forward and aft of the given region of interest. In this way, the inter-region validation check 346 checks to make sure there is consistency between the filtered bulk temperatures 376.

When validated (e.g., when within the predetermined range), the filtered bulk temperatures 376 can be used to determine clearances of a turbomachine. When the filtered bulk temperature 376 is not within the predetermined range of the weighted bulk temperature, then the calculation is corrected to the closest bound (e.g., of the predetermined range) and the calculations resume.

As further shown in FIG. 14, the clearance estimation module 330 can include a clearance estimator 350 that outputs estimated clearances 380 for one or more clearances of interest of a turbomachine. The estimated clearances 380 can be radial, axial, and/or circumferential clearances associated with any section of a turbomachine, such as a compressor section and/or turbine section of a gas turbine, among others. The clearance estimator 350 can utilize the filtered bulk temperatures 376, which can be validated by the inter-region validation check 346, to determine thermal deflections for each component of interest at the respective regions of interest. The determined thermal deflections can be utilized, along with mechanical deflections, to determine clearances for clearances of interest of the turbomachine.

A clearance for a clearance of interest can be determined by summing the total deflections determined for respective components of interest at the region of interest in which the clearance of interest is located, or rather according to Equation 14:

$$CL = \sum {δ}_{1} - \sum {δ}_{2}$$

wherein CL is the clearance for the clearance of interest, Σ δ₁ is the sum of the total deflections for the respective components of interest that affect the clearance of interest in a first direction, and Σ δ₂ is the sum of the total deflections for the respective components of interest that affect the clearance of interest in a second direction, wherein the second direction is opposite the first direction. For instance, for a radial clearance, the first direction can be a radially outward direction, and the second direction can be a radially inward direction. For an axial clearance, the first direction can be an axially forward direction, and the second direction can be an axially aft direction. For a circumferential clearance, the first direction can be a clockwise direction, and the second direction can be a counterclockwise direction.

By way of example, the clearance for the clearance CL1 of FIG. 2 can be determined according to Equation 14 as follows:

$$CL 1 = ( {δ}_{total - rotor} + {δ}_{total - blade} + {δ}_{total - shroud} ) - ( {δ}_{total - casing} )$$

wherein CL1 is the clearance, δₜₒₜₐₗ₋ᵣₒₜₒᵣ is the total deflection of the rotor 24 at the region of interest associated with the clearance CL1, δ_{total-blade} is the total deflection of the rotor blades 28A at the region of interest associated with the clearance CL1, δ_{total-shroud} is the total deflection of the shroud 76A at the region of interest associated with the clearance CL1, and δtotal-casing is the total deflection of the casing 74 at the region of interest associated with the clearance CL1. The total deflections of the rotor 24, rotor blades 28A, and the shroud 76A all influence the clearance CL1 in a first direction, e.g., a radially outward direction, and hence equate to Σ δ₁, the sum of the total deflections for the respective components of interest that affect the clearance of interest in a first direction. The total deflection of the casing 74 influences the clearance CL1 in a second direction, e.g., a radially inward direction, and hence equates to Σ δ₂, the sum of the total deflections for the respective components of interest that affect the clearance of interest in the second direction.

The total deflection for a given component of interest at a region of interest can be determined according to Equation 15:

$${δ}_{total} = {δ}_{thermal} + {δ}_{mechanical}$$

wherein δₜₒₜₐₗ is the total deflection of the given component of interest at the region of interest associated with the clearance of interest, δₜₕₑᵣₘₐₗ is the thermal deflection of the given component of interest at the region of interest associated with the clearance of interest, and δ_{mechanical} is the mechanical deflection of the given component of interest at the region of interest associated with the clearance of interest.

The mechanical deflection for a given component of interest subject to pressure loading is proportionate to the pressure differential across the component as indicated in Equation 16:

$${δ}_{mech , pressure} ∼ ( {P}_{1} - {P}_{2} )$$

wherein δ_{mech,pressure} is the mechanical deflection of the given component of interest at the region of interest associated with the clearance of interest, P₁ is a pressure on a first side of the component of interest at the region of interest, and P₂ is a pressure on a second side of the component of interest at the region of interest, the first side being opposite the second side. The pressures can be measured or estimated using any suitable technique.

The mechanical deflection for a given axisymmetric component subject to rotation about its axis is proportional to the rotational speed squared as indicated in Equation 17:

$${δ}_{mech . , rotational} ∼ mR {ω}^{2}$$

wherein δ_{mech,rotational} is the mechanical deflection of the given component of interest at the region of interest associated with the clearance of interest, ω is the rotational speed of the component of interest at the region of interest, m is the mass of the component of interest at the region of interest, and R is the radius associated with the component of interest at the region of interest.

The thermal deflection for a given component of interest can be calculated according to Equation 18:

$${δ}_{thermal} = L * α * ( {T}_{bulk} - {T}_{ref} )$$

wherein δₜₕₑᵣₘₐₗ is the thermal deflection of the given component of interest at the region of interest associated with the clearance of interest, L is a length of interest or dimension of the component of interest at the region of interest associated with a direction of thermal growth that affects or influences a clearance of interest, α is a linear coefficient of thermal expansion of the component of interest at the region of interest, T_{ref} is the reference temperature (the same reference temperature used during training of the reduced order model), and T_{bulk} is the bulk temperature, which can be a filtered bulk temperature 376 associated with the given component of interest at the region of interest associated with the clearance of interest, or can be the estimated bulk temperature 372 associated with the given component of interest at the region of interest associated with the clearance of interest in embodiments in which the validation module 340 is not included or otherwise not executed. The length of interest L can be a radial length, an axial length, or a circumferential length, for example. In some instances, the length of interest L can be a radius, e.g., of a casing or rotor.

Accordingly, the clearance estimator 350 outputs determined clearances 380 for each clearance of interest, e.g., using Equations 14 through 17. The determined clearances 380 can be used for a number of useful reasons, such as predicting and/or preventing rub events, estimating head room and time needed for restarts, for lifing and/or prognostic health management, and/or adjusting control of a gas turbine, among other things.

As further shown in FIG. 14, the clearance estimation module 330 can optionally include a clearance validation module 360. The clearance validation module 360 can include a clearance Kalman filter 362, such as an unscented Kalman filter, and one or more clearance measurement models 364 that can each provide measured clearances 382 for respective clearances of interest. In other embodiments, one or more of the clearance measurement models 364 can provide measured clearances 382 for multiple clearances of interest. In yet other embodiments, a single measurement model 364 can provide the measured clearances 382 to the clearance Kalman filter 362.

In the depicted embodiment of FIG. 14, the clearance measurement models 364 include a first measurement model 364A configured to estimate or provide measured clearances for a first clearance of interest of a gas turbine (e.g., CL1 of FIG. 2), a second measurement model 364B configured to estimate or provide measured clearances for a second clearance of interest of the gas turbine (e.g., CL2 of FIG. 2), and so on for other clearances of interest as represented by an Nth measurement model 364N, wherein N is an integer greater than or equal to one (or a letter that comes after “B” alphabetically). The clearance measurement models 364 can receive inputs from one or more clearance measurement devices or clearance probes, such as any device capable of performing a known clearance measurement technique, such as an inductive, eddy current, capacitive, microwave, optical fiber, probe, and/or AC discharge method. The clearance measurement models 364 can process the inputs and output their respective measured clearances 382 to the clearance Kalman filter 362.

The clearance Kalman filter 362 receives the estimated clearances 380 from the clearance estimator 350 as well as the measured clearances 382 from the one or more clearance measurement models 364. The clearance Kalman filter 362 can generate an estimated clearance distribution (e.g., a bell curve) and a measured clearance distribution (e.g., a bell curve) for each clearance of interest. For instance, for each clearance of interest, an estimated clearance distribution can be generated based at least in part on the estimated clearance 380 associated with a given clearance of interest, and a measured clearance distribution can be generated based at least in part on the measured clearance 382 associated with the given clearance of interest. The shape of a given distribution represents the uncertainty in the given distribution, with more certain estimates being represented by sharper (narrower) bell curves and less certain estimates being represented by less sharp (wider) curves.

Based at least in part of the estimated clearance distribution and the measured clearance distribution for a given clearance of interest, a filtered clearance 384 for the given clearance of interest can be determined. For instance, the clearance Kalman filter 362 can generate a conditional distribution for a given clearance of interest based at least in part on the estimated clearance distribution and the measured clearance distribution associated with the given clearance of interest. The filtered clearance can be selected as the most likely outcome or clearance of the conditional distribution, for example. Accordingly, the clearance Kalman filter 362 can output filtered clearance 384 for each clearance of interest, with each filtered clearance 384 representing the most likely outcome of its associated conditional distribution. In some embodiments, the estimated and measured clearance distributions 381, 383 can be weighted, and the conditional distribution 385 can be generated according to weights assigned to the estimated and measured clearance distributions 381, 383.

FIG. 17 provides example distributions for a given clearance of interest. The x-axis may be the error between the measurement model and the measured values (i.e., reality), and the y-axis may be the probability density function. As depicted in FIG. 17, the clearance Kalman filter 362 (FIG. 14) can generate an estimated clearance distribution 381 based on the estimated clearance 380 associated with the given clearance of interest, and a measured clearance distribution 383 based on the measured clearance 382 associated with the given clearance of interest. From these two distributions, a joint clearance distribution 385 can be generated. Based on the joint clearance distribution 385 curve, the filtered clearance 384 can be determined, e.g., as the most likely outcome of the joint clearance distribution 385. Notably, the shapes of the curves in FIG. 17 are intended to serve as examples and are not intended to be limiting. The actual distributions may have any suitable shape, and this disclosure should not be limited to the shape shown in FIG. 17 unless specifically recited in the claims.

Returning now to FIG. 14, the filtered clearances 384 can be output from the clearance validation module 360 and out of the clearance estimation module 330 to, e.g., one or more downstream modules 390 so that one or more control actions can be performed based on the filtered clearances 384. In embodiments in which the clearance validation module 360 is not included or otherwise not executed, the estimated clearances 380 output by the clearance estimator 350 can be output from the clearance estimation module 330, e.g., to the one or more downstream modules 390 so that one or more control actions can be performed based on the estimated clearances 380. Example downstream modules 390 can include, without limitation, a gas turbine control 392 configured to control aspects of a gas turbine based at least in part on clearances received from the clearance estimation module 330, a lifing and/or Prognostic Health Management (PHM) analyzer 398 configured to analyze the health of a gas turbine or components thereof based at least in part on clearances received from the clearance estimation module 330, maintenance and/or service modules, a data recorder, etc., among other possible downstream modules.

In some example embodiments, as depicted in FIG. 14, the filtered clearances 384 and/or clearance estimates 380 can be output from the clearance estimation module 330 and routed to the gas turbine control 392, which as noted above, is configured to control aspects of a gas turbine based at least in part on clearances received from the clearance estimation module 330. The gas turbine control 392, when executed by one or more processors of the computing system 300, can be configured to output control commands 394, e.g., to one or more controllable devices 396 of a gas turbine. Example controllable devices 394 can include valves, actuators, switches, etc., among other known controllable devices of a gas turbine. The controllable devices 396 can be controlled based at least in part on control commands 394. For instance, if a clearance determined for a clearance of interest is determined to be too open, one or more of the controllable devices 396 can be commanded via the control command 394 to reduce the clearance of the clearance of interest. If, in contrast, the clearance determined for the clearance of interest is determined to be too closed, one or more of the controllable devices 396 can be commanded via the control command 394 to increase the clearance of the clearance of interest.

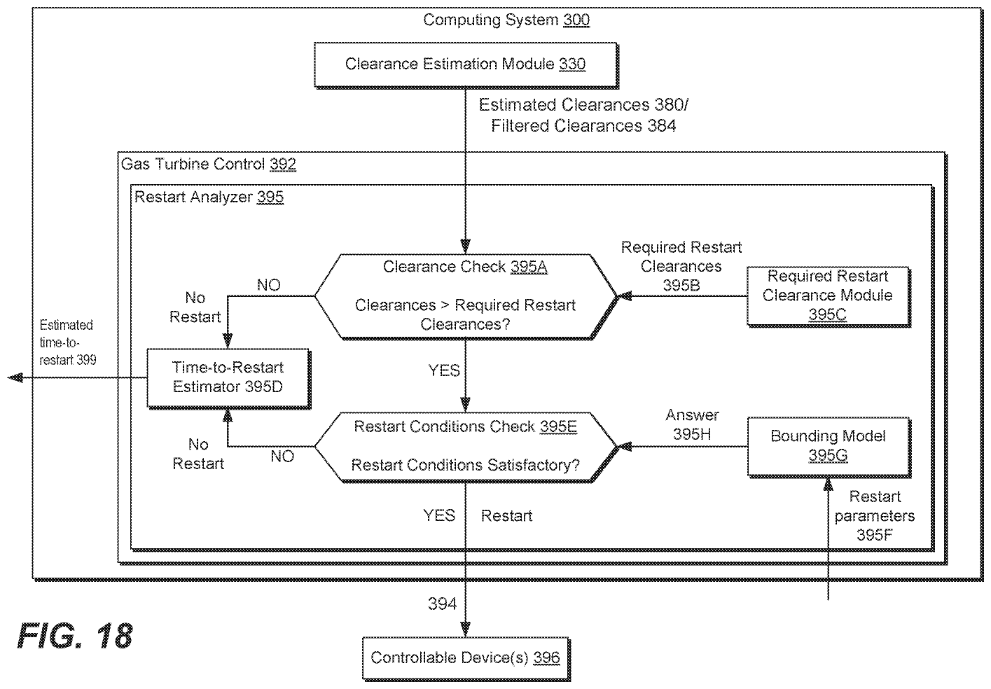

In some further embodiments, with reference now to FIGS. 14 and 18, the gas turbine control 392 can include a restart analyzer 395. The restart analyzer 395, when executed by one or more processors of the computing system 300, can be configured to determine whether clearance conditions are favorable to permit a gas turbine to be restarted after a shutdown. As shown in FIG. 18, the estimated clearances 380 or filtered clearances 384 can be output from the clearance estimation module 330 and input into a clearance check 395A. At the clearance check 395A, it is determined whether the clearances, which may be the estimated clearances 380 or filtered clearances 384, are greater than their respective required restart clearances 395B. That is, the estimated clearance 380 or filtered clearance 384 associated with a given clearance of interest is compared to the required restart clearance 395B associated with the given clearance of interest. Such comparisons are made for each clearance of interest. The required restart clearances 395B are received from a required restart clearance module 395C that determines the required restart clearances 395B, e.g., based on one or more operating conditions associated with the gas turbine, such as ambient temperature or pressure.

When one or more of the clearances (the estimated clearances 380 or filtered clearances 384) are not greater than their respective required restart clearances 395B, the gas turbine is not restarted, and the logic proceeds to a time-to-restart estimator 395D. The time-to-restart estimator 395D, when executed, determines and outputs an estimated time-to-restart 399 the gas turbine, which can be in units of time (e.g., seconds, minutes, hours, etc.). The determined estimated time-to-restart 399 can be output as a “time remaining” until it is predicted the gas turbine will be ready for a restart and/or as an exact time at which it is predicted the gas turbine will be ready for a restart. The time-to-restart estimator 395D can determine the time-to-restart 399 the gas turbine based at least in part on, e.g., the magnitude of the difference between one or more of the estimated/filtered clearances 380, 384 and their respective required restart clearances 395B, one or more operating conditions associated with the gas turbine (e.g., the ambient air temperature or pressure), the time since shutdown, etc. The estimated time-to-restart 399 the gas turbine can be output to one or more entities, e.g., an operator of the gas turbine (e.g., via a display or alert), to maintenance and/or service personnel, etc.

When all or at least a predetermined number or preselected group of clearances (the estimated clearances 380 or filtered clearances 384) are greater than their respective required restart clearances 395B, the logic proceeds, optionally, to a restart conditions check 395E. The restart conditions check 395E, when executed, determines whether restart conditions are satisfactory for a restart of a gas turbine as determined by a bounding model 395G.

The bounding model 395G can receive restart parameters 395F that can include, without limitation, a casing temperature of a casing of a gas turbine, an ambient temperature surrounding the gas turbine, a turbine warming system temperature at a turbine warming system of the gas turbine, and a turbine inlet temperature of a turbine of the gas turbine. Such temperatures can be sensed by one or more thermocouples of the gas turbine, for example. The restart parameters 395F can be used by the bounding model 395G to determine whether one or more restart conditions are within predetermined bounds.

In some example embodiments, for example, the bounding model 395G can be executed to determine whether a first restart condition is satisfied. Particularly, the bounding model 395G can be executed to determine whether a casing temperature T_{case} is less than a sum of an ambient temperature T_{amb} and a first variable X, or rather, whether T_{case}<T_{amb}+X. When the casing temperature T_{case} is less than the sum of the ambient temperature T_{amb} and the first variable X, then the first restart condition is determined to be satisfied by the bounding model 395G (or within predetermined bounds), and accordingly, the answer 395H provided to the restart conditions check 395E is “Yes” or “True”. Consequently, in such instances, the gas turbine can be restarted. In contrast, when the casing temperature T_{case} is not less than the sum of the ambient temperature T_{amb} and the first variable X, then the first restart condition is determined not to be satisfied by the bounding model 395G (or not within predetermined bounds), and therefore, the answer 395H provided to the restart conditions check 395E is “No” or “False”. In such instances, the gas turbine is not restarted. The first variable X can be a temperature value between about 100° F. and about 200° F. (between about 38° C. and about 93° C.), or such as between about 120° F. and about 160° F. (between about 49° C. and about 71° C.), or such as about 140° F. (about 60° C.).

Further, in such example embodiments, the bounding model 395G can be executed to determine whether a second restart condition is satisfied. Particularly, the bounding model 395G can be executed to determine whether a turbine warming system temperature T_{ws} is greater than a sum of a turbine inlet temperature Tᵢₙ and a second variable Y, or rather, whether T_{ws}>Tᵢₙ+Y. When the turbine warming system temperature T_{ws} is greater than the sum of the turbine inlet temperature Tᵢₙ and the second variable Y, then the second restart condition is determined not to be satisfied by the bounding model 395G (or not within predetermined bounds), and accordingly, the answer 395H provided to the restart conditions check 395E is “No” or “False”. Consequently, in such instances, the gas turbine is not restarted. In contrast, when the turbine warming system temperature T_{ws} is not greater than the sum of the turbine inlet temperature Tᵢₙ and the second variable Y, then the second restart condition is determined to be satisfied by the bounding model 395G (or within predetermined bounds), and accordingly, the answer 395H provided to the restart conditions check 395E is “Yes” or “True”. As a result, in such instances, the gas turbine can be restarted. The second variable Y can be a temperature value between about 100° F. and about 200° F. (between about 38° C. and about 93° C.), or such as between about 120° F. and about 160° F. (between about 49° C. and about 71° C.), or such as about 140° F. (about 60° C.).

In some embodiments, when the answer 395H provided to the restart conditions check 395E is “No” or “False,” the restart conditions check 395E can forward information to the time-to-restart estimator 395D. For instance, such information can include which restart condition or conditions were not satisfied, a magnitude of the difference between the casing temperature T_{case} and the sum of the ambient temperature T_{amb} and the first variable X, and/or a magnitude of the difference between the turbine warming system temperature T_{ws} and the sum of the turbine inlet temperature Tᵢₙ and the second variable Y. Such information can be used by the time-to-restart estimator 395D to output the estimated time-to-restart 399 of the gas turbine.

As further shown in FIG. 18, when the answer 395H provided to the restart conditions check 395E is “Yes” or “True,” the gas turbine control 392 can output the one or more control commands 394 to the one or more controllable devices 396, and based on the control commands 394, the one or more controllable devices 396 can cause the gas turbine to restart, e.g., by delivering a fuel, ignition, etc. to spool up the gas turbine.

It will be appreciated that the control logic of the restart analyzer 395 set forth above and in FIG. 18 is provided by way of example, and that in other example embodiments, the control logic can include other suitable modules, models, components, etc. For example, in some other embodiments, the restart conditions check 395E and/or the time-to-restart estimator 395D can be omitted or otherwise not executed by the one or more processors of the computing system 300. Further, it will be appreciated that the restart analyzer 395 is one of many possible modules of the gas turbine control 392 that can utilize the estimated/filtered clearances 380, 384 in a useful manner. For instance, the gas turbine control 392 can additionally or alternatively include an active clearance control module operable to control an active clearance control system configured to actively control clearances of interest, a rub prediction module for predicting and/or confirming the occurrence of rub events, a head room estimator module, and/or other modules for active control of the gas turbine before, during, or after operation of a gas turbine.

In addition, with reference to FIG. 14, the estimated/filtered clearances 380, 384 can be used in a useful manner by the lifing and/or PHM analyzer 398. For instance, the lifing and/or PHM analyzer 398 can utilize the estimated/filtered clearances 380, 384 to determine deterioration and/or a remaining useful life of one or more components, assemblies, and/or systems of a gas turbine. Particularly, the estimated/filtered clearances 380, 384 can be tracked over time to determine trends and then prognostically project such trends into the future to predict the remaining useful of one or more components, assemblies, and/or systems of a gas turbine.

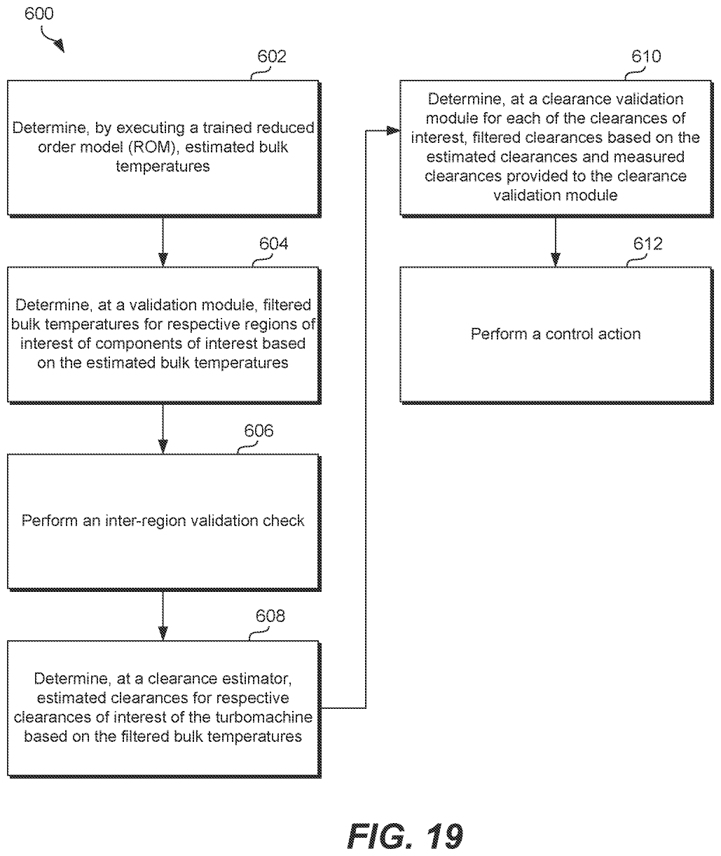

FIG. 19 provides a flow diagram for a method 600 of estimating clearances for one or more clearances of interest of a turbomachine. Particularly, the method 600 can include using and validating a reduced order model, which has been trained to represent one more complex physics-based models (e.g., trained in accordance with the method 500 of FIG. 13), to output estimates that can be used to determine clearances for a turbomachine. The method 600 is provided by way of example, and in alternative implementations, operations of the method 600 can be modified, adapted, expanded, rearranged and/or omitted in various ways without deviating from the scope of the present subject matter.

At 602, the method 600 includes determining, by executing a trained reduced order model (ROM), the estimated bulk temperatures based at least in part on input predictors input into the trained ROM and model parameters tuned during training of the trained ROM. The input predictors include one or more sensed inputs and/or one or more virtual inputs derived from the one or more sensed inputs. The determined estimated bulk temperatures can be output from the trained ROM.

At 604, the method 600 includes determining, at a validation module for each of the regions of interest of the one or more components of interest, a filtered bulk temperature, the filtered bulk temperature for a given region of interest of the regions of interest being determined based at least in part on the estimated bulk temperature and a measured bulk temperature determined independently from the reduced order model. In some implementations, the one or more measurement models include at least one measurement model for every one of the one or more components of interest for which the trained reduced order model outputs estimated bulk temperatures.

In some implementations, the validation module can include a Kalman filter and one or more measurement models. The one or more measurement models can provide the measured bulk temperatures to the Kalman filter. In such implementations, determining the filtered bulk temperature for a given region of interest can include generating, by executing the Kalman filter, an estimated bulk temperature distribution based at least in part on the estimated bulk temperature associated with the given region of interest; generating, by executing the Kalman filter, a measured bulk temperature distribution based at least in part on the measured bulk temperature associated with the given region of interest; and generating, by executing the Kalman filter, a conditional distribution based at least in part on the estimated bulk temperature distribution and the measured bulk temperature distribution. In such implementations, the filtered bulk temperature can be determined using the conditional distribution. For instance, the filtered bulk temperature can be selected as the most likely outcome or temperature of the conditional distribution.

At 606, the method 600 includes performing an inter-region validation check. In some implementations, performing the inter-region validation check can include determining, for at least one of the regions of interest of the one or more components of interest, a weighted inter-region bulk temperature, the weighted inter-region bulk temperature for the at least one region of interest being determined as an average of a first bulk temperature associated with a first region of interest of the regions of interest positioned upstream of the at least one region of interest and a second bulk temperature associated with a second region of interest of the regions of interest positioned downstream of the at least one region of interest; and determining whether the filtered bulk temperature associated with the at least one region of interest is within a predetermined range of the weighted inter-region bulk temperature.

At 608, the method 600 includes determining, at a clearance estimator, estimated clearances for respective clearances of interest of the turbomachine based at least in part on the filtered bulk temperatures.

In some implementations, determining, at the clearance estimator, the estimated clearances for respective clearances of interest of the turbomachine based at least in part on the filtered bulk temperatures includes, for a given clearance of interest of the clearances of interest, determining a thermal deflection associated with each component of interest in the region of interest in which the given clearance of interest is positioned; determining a mechanical deflection associated with each component of interest in the region of interest in which the given clearance of interest is positioned; and determining a total deflection associated with each component of interest in the region of interest in which the given clearance of interest is positioned, the total deflection for a given component of interest in the region of interest in which the given clearance of interest is positioned being determined based at least in part on the thermal deflection and the mechanical deflection associated with the given component of interest. In such implementations, the clearance associated with the given clearance of interest is determined as a sum of the total deflections for the respective components of interest that affect the given clearance of interest in a first direction less a sum of the total deflections for the respective components of interest that affect the given clearance of interest in a second direction, wherein the second direction is opposite the first direction.

At 610, the method 600 includes determining, at a clearance validation module for each of the clearances of interest, a filtered clearance, the filtered clearance for a given clearance of interest being determined based at least in part on the estimated clearance and a measured clearance each associated with the given clearance of interest.

In some implementations, the clearance validation module has a clearance Kalman filter and one or more clearance measurement models. The one or more clearance measurement models can provide the measured clearances to the clearance Kalman filter. In such implementations, the step of determining the filtered clearance for a given clearance of interest can include generating, by executing the clearance Kalman filter, an estimated clearance distribution based at least in part on the estimated clearance associated with the given clearance of interest; generating, by executing the clearance Kalman filter, a measured clearance distribution based at least in part on the measured clearance associated with the given clearance of interest; and generating, by executing the clearance Kalman filter, a joint clearance distribution based at least in part on the estimated clearance distribution and the measured clearance distribution. In such implementations, the filtered clearance for the given clearance of interest is determined using the joint clearance distribution. For instance, the filtered clearance can be selected as the most likely outcome or clearance of the joint clearance distribution.

At 612, the method 600 includes performing a control action based at least in part on the estimated and/or filtered clearances.

In some implementations, performing the control action includes causing one or more controllable devices of the turbomachine to change an operating point of the turbomachine based at least in part on the estimated clearances.

In some further implementations, performing the control action includes modifying a load curve of an electric machine mechanically coupled to the turbomachine. In some other implementations, performing the control action includes modifying a speed curve of the turbomachine.

In other implementations, performing the control action includes a lifing and/or prognostic life management analysis of one or more components, assemblies, and/or systems of the turbomachine based at least in part on the estimated clearances.

In yet further implementations, performing the control action includes determining, upon executing a restart analyzer of a turbomachine, whether one or more conditions are satisfied to restart the turbomachine based at least in part on the estimated clearances. In such implementations, when the one or more conditions are satisfied, the turbomachine can be caused to restart. In contrast, when the one or more conditions are not satisfied, the turbomachine can be caused not to restart.

In some further implementations, in determining, upon executing the restart analyzer, whether the one or more conditions are satisfied to restart the turbomachine based at least in part on the estimated clearances, performing the control action can further include at least one of: i) determining whether the estimated clearances are greater than respective ones of a plurality of required restart clearances; or ii) determining whether one or more restart conditions are satisfied based at least on one or more restart parameters.

In some implementations, when the estimated clearances are not greater than the respective ones of the plurality of required restart clearances, performing the control action can include determining, by executing a time-to-restart estimator, an estimated time-to-restart the turbomachine based at least in part on a magnitude of a difference between at least one of the estimated clearances and a required restart clearance each associated with a given one of the clearances of interest; and outputting the estimated time-to-restart the turbomachine to one or more entities.

In some implementations, the method includes training the reduced order model to produce the trained reduced order model. Training the reduced order model can include (a) determining, for each of the regions of interest of the one or more components of interest of the turbomachine, a baseline bulk temperature; (b) determining, for each one of the regions of interest, a cooling/heating effectiveness, the cooling/heating effectiveness for a given one of the regions of interest being determined as a function of a flow rate of fluid streams flowing relative to the component of interest in the given one of the regions of interest; (c) defining one or more nodes for each one of the regions of interest; (d) calculating a nodal cooling/heating effectiveness for each node of the one or more nodes, the nodal cooling/heating effectiveness for a given node of the one or more nodes being calculated as a function of the cooling/heating effectiveness associated with the given node; (e) calculating a nodal bulk temperature for each one of the one or more nodes, the nodal bulk temperature for a given node of the one or more nodes being calculated based at least in part on a nodal time constant, a nodal potential temperature determined based at least in part on the nodal cooling/heating effectiveness associated with the given node, and a previous nodal bulk temperature, each of which is associated with the given node; (f) determining, for each one of the regions of interest, a combined bulk temperature, the combined bulk temperature for a given region of interest of the regions of interest being determined by combining the nodal bulk temperatures associated the given region of interest; (g) determining, for each one of the regions of interest, respective bulk temperature errors and/or respective thermal deflection errors based at least in part on respective ones of the combined bulk temperatures and respective ones of the baseline bulk temperatures; and (h) iterating implementation of (a) through (g) to reduce the respective thermal deflection errors and/or the respective bulk temperature errors toward zero error by adjusting one or more tuning parameters.

FIG. 20 provides an example computing system 1000 according to example embodiments of the present disclosure. The computing elements or systems described herein can include one, some, or all the components of the computing system 1000 and can execute operations as described below. For instance, the computing system 50 and/or the computing system 300 provided herein can be configured in a similar or identical manner as the computing system 1000 of FIG. 20.

As shown in FIG. 20, the computing system 1000 can include one or more computing device(s) 1010. The computing device(s) 1010 can include one or more processor(s) 1010A and one or more memory device(s) 1010B. The one or more processor(s) 1010A can include any processing device, such as a microprocessor, microcontroller, integrated circuit, logic device, and/or other suitable processing device. The one or more memory device(s) 1010B can include one or more computer-readable media, including, but not limited to, a non-transitory computer-readable medium, RAM, ROM, hard drives, flash drives, and/or other memory devices.

The one or more memory device(s) 1010B can store information accessible by the one or more processor(s) 1010A, including computer-executable or computer-readable instructions 1010C that can be executed by the one or more processor(s) 1010A. The instructions 1010C can be any set of instructions that, when executed by the one or more processor(s) 1010A, cause the one or more processor(s) 1010A to perform operations. In some embodiments, the instructions 1010C can be executed by the one or more processor(s) 1010A to cause the one or more processor(s) 1010A to perform operations, such as any of the operations and functions for which the computing system 1000 and/or the computing device(s) 1010 are configured. The instructions 1010C can be software written in any programming language or can be implemented in hardware. Additionally, and/or alternatively, the instructions 1010C can be executed in logically and/or virtually separate threads on processor(s) 1010A. The memory device(s) 1010B can further store data 1010D that can be accessed by the processor(s) 1010A.

The computing device(s) 1010 can also include a network interface 1010E used to communicate, for example, with the other components of the computing system 1000, sensors, controllable devices, etc. (e.g., via a network). The network interface 1010E can include components for interfacing with one or more network(s), including for example, transmitters, receivers, ports, controllers, antennas, and/or other suitable components.

The technology discussed herein makes reference to computer-based systems and actions taken by and information sent to and from computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

Further aspects of the invention are provided by the subject matter of the following clauses:

A system for estimating clearances of a turbomachine, the system comprising: one or more memory devices; and one or more processors configured to: output, from a trained reduced order model (ROM) for each region of interest of one or more components of interest of the turbomachine, an estimated bulk temperature; determine, at a validation module for each of the regions of interest, a filtered bulk temperature, the filtered bulk temperature of a given component of interest of the one or more components of interest in a given region of interest of the regions of interest being determined based at least in part on the estimated bulk temperature and a measured bulk temperature each associated with the given component of interest at the given region of interest, the measured bulk temperature being determined independently of the trained ROM; determine, at a clearance estimator for each clearance of interest of the turbomachine, an estimated clearance, the estimated clearance for a given clearance of interest of the clearances of interest being determined based at least in part on the filtered bulk temperatures associated with the region of interest in which the given clearance of interest is positioned; and perform a control action based at least in part on the estimated clearances.

The system of any preceding clause, wherein the validation module has a Kalman filter and one or more measurement models, and wherein the one or more measurement models provide the measured bulk temperatures to the Kalman filter.

The system of any preceding clause, wherein the one or more measurement models include at least one measurement model for every one of the one or more components of interest.

The system of any preceding clause, wherein, in determining the filtered bulk temperature for the given region of interest, the one or more processors are configured to: generate, by executing the Kalman filter, an estimated bulk temperature distribution based at least in part on the estimated bulk temperature associated with the given region of interest; generate, by executing the Kalman filter, a measured bulk temperature distribution based at least in part on the measured bulk temperature associated with the given region of interest; generate, by executing the Kalman filter, a conditional distribution based at least in part on the estimated bulk temperature distribution and the measured bulk temperature distribution, and wherein the filtered bulk temperature is determined using the conditional distribution.

The system of any preceding clause, wherein the one or more processors are further configured to: determine, for at least one of the regions of interest of the one or more components of interest, a weighted inter-region bulk temperature, the weighted inter-region bulk temperature for the at least one region of interest being determined as an average of a first bulk temperature associated with a first region of interest of the regions of interest positioned upstream of the at least one region of interest and a second bulk temperature associated with a second region of interest of the regions of interest positioned downstream of the at least one region of interest; and determine whether the filtered bulk temperature associated with the at least one region of interest is within a predetermined range of the weighted inter-region bulk temperature.

The system of any preceding clause, wherein, in determining, at the clearance estimator, the estimated clearances for respective clearances of interest of the turbomachine based at least in part on the filtered bulk temperatures, the one or more processors are configured to: for a given clearance of interest of the clearances of interest, determine a thermal deflection associated with each component of interest in the region of interest in which the given clearance of interest is positioned; determine a mechanical deflection associated with each component of interest in the region of interest in which the given clearance of interest is positioned; determine a total deflection associated with each component of interest in the region of interest in which the given clearance of interest is positioned, the total deflection for a given component of interest in the region of interest in which the given clearance of interest is positioned being determined based at least in part on the thermal deflection and the mechanical deflection associated with the given component of interest, and wherein the clearance associated with the given clearance of interest is determined as a sum of the total deflections for the respective components of interest that affect the given clearance of interest in a first direction less a sum of the total deflections for the respective components of interest that affect the given clearance of interest in a second direction, wherein the second direction is opposite the first direction.

The system of any preceding clause, wherein the one or more processors are further configured to: determine, at a clearance validation module for each of the clearances of interest, a filtered clearance, the filtered clearance for a given clearance of interest being determined based at least in part on the estimated clearance and a measured clearance each associated with the given clearance of interest.

The system of any preceding clause, wherein the clearance validation module has a clearance Kalman filter and one or more clearance measurement models, and wherein the one or more clearance measurement models provide the measured clearances to the clearance Kalman filter, and wherein, in determining the filtered clearance for the given clearance of interest, the one or more processors are configured to: generate, by executing the clearance Kalman filter, an estimated clearance distribution based at least in part on the estimated clearance associated with the given clearance of interest; generate, by executing the clearance Kalman filter, a measured clearance distribution based at least in part on the measured clearance associated with the given clearance of interest; generate, by executing the clearance Kalman filter, a joint clearance distribution based at least in part on the estimated clearance distribution and the measured clearance distribution, and wherein the filtered clearance is determined using the joint clearance distribution.

The system of any preceding clause, wherein the one or more processors are further configured to: output, from the validation module, the filtered bulk temperatures to the trained ROM.

The system of any preceding clause, wherein the one or more processors are further configured to: receive, in the trained ROM, input predictors; determine, by executing the trained ROM, the estimated bulk temperatures based at least in part on the input predictors and model parameters tuned during training of the trained ROM; and output, by the trained ROM, the estimated bulk temperatures to the validation module.

The system of claim 1, wherein the one or more processors are configured to generate the trained ROM by executing a training module, wherein in executing the training module, the one or more processors are configured to: (a) determine, for each of the regions of interest of the one or more components of interest of the turbomachine, a baseline bulk temperature; (b) determine, for each one of the regions of interest, a cooling/heating effectiveness, the cooling/heating effectiveness for a given one of the regions of interest being determined as a function of a flow rate of fluid streams flowing relative to the component of interest in the given one of the regions of interest; (c) define one or more nodes for each one of the regions of interest; (d) calculate a nodal cooling/heating effectiveness for each node of the one or more nodes, the nodal cooling/heating effectiveness for a given node of the one or more nodes being calculated as a function of the cooling/heating effectiveness associated with the given node; (e) calculate a nodal bulk temperature for each one of the one or more nodes, the nodal bulk temperature for a given node of the one or more nodes being calculated based at least in part on a nodal time constant, a nodal potential temperature determined based at least in part on the nodal cooling/heating effectiveness associated with the given node, and a previous nodal bulk temperature, each of which is associated with the given node; (f) determine, for each one of the regions of interest, a combined bulk temperature, the combined bulk temperature for a given region of interest of the regions of interest being determined by combining the nodal bulk temperatures associated the given region of interest; (g) determine, for each one of the regions of interest, respective bulk temperature errors and/or respective thermal deflection errors based at least in part on respective ones of the combined bulk temperatures and respective ones of the baseline bulk temperatures; and (h) iterate implementation of (a) through (g) to reduce the respective thermal deflection errors and/or the respective bulk temperature errors toward zero error by adjusting one or more tuning parameters.

The system of any preceding clause, wherein, in performing the control action based at least in part on the estimated clearances, the one or more processors are configured to: cause one or more controllable devices of the turbomachine to change an operating point of the turbomachine based at least in part on the estimated clearances.

The system of any preceding clause, wherein, in performing the control action based at least in part on the estimated clearances, the one or more processors are configured to: determine, upon executing a restart analyzer, whether one or more conditions are satisfied to restart the turbomachine based at least in part on the estimated clearances, and wherein when the one or more conditions are satisfied, the one or more processors are configured to cause the turbomachine to restart.

The system of any preceding clause, wherein in determining, upon executing the restart analyzer, whether the one or more conditions are satisfied to restart the turbomachine based at least in part on the estimated clearances, the one or more processors are configured to perform at least one of: i) determine whether the estimated clearances are greater than respective ones of a plurality of required restart clearances; or ii) determine whether one or more restart conditions are satisfied based at least on one or more restart parameters.

The system of any preceding clause, wherein when the estimated clearances are not greater than the respective ones of the plurality of required restart clearances, the one or more processors are configured to: determine, by executing a time-to-restart estimator, an estimated time-to-restart the turbomachine based at least in part on a magnitude of a difference between at least one of the estimated clearances and a required restart clearance each associated with a given one of the clearances of interest; and output the estimated time-to-restart the turbomachine to one or more entities.

A method of estimating clearances of a turbomachine, the method comprising: outputting, from a reduced order model for each region of interest of one or more components of interest of the turbomachine, an estimated bulk temperature; determining, at a validation module for each of the regions of interest of the one or more components of interest, a filtered bulk temperature, the filtered bulk temperature for a given region of interest of the regions of interest being determined based at least in part on the estimated bulk temperature and a measured bulk temperature determined independently from the reduced order model; determining, at a clearance estimator, estimated clearances for respective clearances of interest of the turbomachine based at least in part on the filtered bulk temperatures; and performing a control action based at least in part on the estimated clearances.

The method of any preceding clause, wherein the validation module has a Kalman filter and one or more measurement models, and wherein the one or more measurement models provide the measured bulk temperatures to the Kalman filter, and wherein determining the filtered bulk temperature for the given region of interest comprises: generating, by executing the Kalman filter, an estimated bulk temperature distribution based at least in part on the estimated bulk temperature associated with the given region of interest; generating, by executing the Kalman filter, a measured bulk temperature distribution based at least in part on the measured bulk temperature associated with the given region of interest; generating, by executing the Kalman filter, a conditional distribution based at least in part on the estimated bulk temperature distribution and the measured bulk temperature distribution, and wherein the filtered bulk temperature is determined using the conditional distribution.

The method of any preceding clause, further comprising: determining, for at least one of the regions of interest of the one or more components of interest, a weighted inter-region bulk temperature, the weighted inter-region bulk temperature for the at least one region of interest being determined as an average of a first bulk temperature associated with a first region of interest of the regions of interest positioned upstream of the at least one region of interest and a second bulk temperature associated with a second region of interest of the regions of interest positioned downstream of the at least one region of interest; and determining whether the filtered bulk temperature associated with the at least one region of interest is within a predetermined range of the weighted inter-region bulk temperature.

The method of any preceding clause, further comprising: determining, at a clearance validation module for each of the clearances of interest, a filtered clearance, the filtered clearance for a given clearance of interest being determined based at least in part on the estimated clearance and a measured clearance each associated with the given clearance of interest.

A non-transitory computer readable medium comprising computer-executable instructions, which, when executed by one or more processors of a computing system associated with a turbomachine, cause the one or more processors to: output, from a trained reduced order model (ROM) for each region of interest of one or more components of interest of the turbomachine, an estimated bulk temperature; determine, at a validation module for each of the regions of interest, a filtered bulk temperature, the filtered bulk temperature of a given component of interest of the one or more components of interest in a given region of interest of the regions of interest being determined based at least in part on the estimated bulk temperature and a measured bulk temperature each associated with the given component of interest at the given region of interest, the measured bulk temperature being determined independently of the trained ROM; determine, at a clearance estimator for each clearance of interest of the turbomachine, an estimated clearance, the estimated clearance for a given clearance of interest of the clearances of interest being determined based at least in part on the filtered bulk temperatures associated with the region of interest in which the given clearance of interest is positioned; and perform a control action based at least in part on the estimated clearances.

A system, comprising: one or more memory devices; and one or more processors configured to execute a training module to train a reduced order model that, when trained, is configured to output estimates usable for determining clearances of a turbomachine; wherein, in executing the training module, the one or more processors are configured to: (a) determine, for each region of interest of a component of interest of the turbomachine, a baseline bulk temperature; (b) determine, for each one of the regions of interest, a cooling/heating effectiveness, the cooling/heating effectiveness for a given one of the regions of interest being determined as a function of a flow rate of fluid streams flowing relative to the component of interest in the given one of the regions of interest; (c) define one or more nodes for each one of the regions of interest; (d) calculate a nodal cooling/heating effectiveness for each node of the one or more nodes, the nodal cooling/heating effectiveness for a given node of the one or more nodes being calculated as a function of the cooling/heating effectiveness associated with the region of interest of the given node; (e) calculate a nodal bulk temperature for each one of the one or more nodes, the nodal bulk temperature for a given node of the one or more nodes being calculated based at least in part on a nodal time constant, a nodal potential temperature determined based at least in part on the nodal cooling/heating effectiveness associated with the given node, and a previous nodal bulk temperature, each of which is associated with the given node; (f) determine, for each one of the regions of interest, a combined bulk temperature, the combined bulk temperature for a given region of interest of the regions of interest being determined by combining the nodal bulk temperatures associated the given region of interest; (g) determine, for each one of the regions of interest, respective bulk temperature errors and/or respective thermal deflection errors based at least in part on respective ones of the combined bulk temperatures and respective ones of the baseline bulk temperatures; and (h) iterate implementation of (a) through (g) to reduce the respective thermal deflection errors and/or the respective bulk temperature errors toward zero error by adjusting one or more tuning parameters.

The system of any preceding clause, wherein the baseline bulk temperatures determined at (a) for respective ones of the regions of interest are determined based at least in part on known thermal deflections associated with the respective ones of the regions of interest, the known thermal deflections being derived from one or more models that the ROM is trained to represent.

The system of any preceding clause, wherein in executing the training module, the one or more processors are further configured to: calculate, for each one of the regions of interest, a hot free stream temperature and a cold free stream temperature, the hot and cold free stream temperatures being calculated for a given region of interest of the regions of interest based on fluid flowing relative to the component of interest in the given region of interest; and wherein the nodal potential temperature for a given node of the one or more nodes is determined at (e) based at least in part on i) the hot and cold free stream temperatures calculated for the region of interest associated with the given node, and ii) a number of nodes defined for the region of interest associated with the given node.

The system of any preceding clause, wherein the cooling/heating effectiveness for a given one of the regions of interest is determined at (b) by scaling a calculated cooling/heating effectiveness as a function of a number of transfer units using an iterative curve matching technique.

The system of any preceding clause, wherein the calculated cooling/heating effectiveness is determined based at least in part on the number of transfer units, a ratio of a minimum mass flow rate of hot fluid streams flowing relative to the component of interest in the given region of interest to a maximum mass flow rate of cold fluid streams flowing relative to the component of interest in the given region of interest, the number of transfer units being determined based at least in part on an overall heat transfer rate at the given region of interest and a minimum mass flow rate of the hot fluid streams and the cold fluid streams.

The system of any preceding clause, wherein the nodal cooling/heating effectiveness for a given one of the nodes is calculated at (d) as a function of the cooling/heating effectiveness associated with the given one of the nodes such that a sum of the nodal cooling/heating effectiveness for the given one of the nodes and other nodal cooling/heating effectivenesses associated with the cooling/heating effectiveness is equal to the cooling/heating effectiveness.

The system of any preceding clause, wherein, in executing the training module, the one or more processors are further configured to: calculate, for each one of the nodes, a nodal time constant as a function of flow rate using a lump capacitance method.

The system of any preceding clause, wherein the nodal bulk temperature associated a given one of the regions of interest are combined into the combined bulk temperature at (f) according to:

$${T}_{bulk - combined} ( t ) = {\sum }_{i = 1}^{N} {T}_{nodal ( i )} ( t ) - ( N - 1 ) * {T}_{ref}$$

wherein T_{bulk-combined}(t) is the combined bulk temperature for the given region of interest at a given time point, Σᵢ₌₁^{N} T_{nodal(i)}(t) is the sum of the nodal bulk temperatures associated with the region of interest for the given time point, N is a number of nodes associated with the given region of interest, and T_{ref} is a reference temperature utilized to determine the baseline bulk temperature for the given region of interest.

The system of any preceding clause, wherein in executing the training module to determine, for each one of the regions of interest, the respective bulk temperature errors and/or the respective thermal deflection errors at (g), the one or more processors are configured to: (1) (A) convert each one of the combined bulk temperatures into respective thermal deflections; (B) compare the respective thermal deflections to respective known thermal deflections; and (C) determine respective thermal deflection errors based at least in part on the comparison.

The system of any preceding clause, wherein in executing the training module to determine, for each one of the regions of interest, the respective bulk temperature errors and/or the respective thermal deflection errors at (g), the one or more processors are configured to: (2) (A) compare respective ones of the combined bulk temperatures to respective baseline bulk temperatures; and (B) determine respective bulk temperature errors based at least in part on the comparing of the respective ones of the combined bulk temperatures to the respective baseline bulk temperatures.

The system of any preceding clause, wherein the one or more parameters tuned at (h) include effectiveness weights that are utilized to determine respective ones of the nodal cooling/heating effectivenesses at (d).

The system of any preceding clause, wherein the component of interest is one of a plurality of components of interest of the turbomachine for which (a) through (h) are implemented, the plurality of components of interest including a rotor and a casing.

The system of any preceding clause, wherein the regions of interest correspond with stages of a turbine and/or a compressor of the turbomachine.

The system of any preceding clause, wherein in executing the training module, the one or more processors are configured to iterate, at (h), implementation of (a) through (g) to reduce the respective thermal deflection errors and/or the respective bulk temperature errors by adjusting the one or more tuning parameters until the respective thermal deflection errors and/or the respective bulk temperature errors are at least one of: i) within a predetermined error margin of a threshold number; or ii) reduced to a predetermined error threshold.

A method of training a reduced order model (ROM), that when trained, is operable to output estimates usable for determining clearances of a turbomachine, the method comprising:_(a) determining, for a component of interest of the turbomachine, a baseline bulk temperature for each region of interest associated with the component of interest;_(b) determining, for each one of the regions of interest, a cooling/heating effectiveness, the cooling/heating effectiveness for a given one of the regions of interest being determined as a function of a flow rate of fluid streams flowing relative to the component of interest at the given one of the regions of interest; (c) defining one or more nodes for each one of the regions of interest;_(d) calculating a nodal cooling/heating effectiveness for each node of the one or more nodes, the nodal cooling/heating effectiveness for a given node of the one or more nodes being calculated as a function of the cooling/heating effectiveness associated with the given node;_(e) calculating a nodal bulk temperature for each one of the one or more nodes, the nodal bulk temperature for a given node of the one or more nodes being calculated based at least in part on a nodal time constant, a nodal potential temperature determined based at least in part on the nodal cooling/heating effectiveness associated with the given node, and a previous nodal bulk temperature, each of which is associated with the given node;_(f) determining, for each one of the regions of interest, a combined bulk temperature, the combined bulk temperature for a given one of the regions of interest being determined by combining the nodal bulk temperatures associated with the given one of the regions of interest;_(g) determining, for each one of the regions of interest, respective bulk temperature errors and/or respective thermal deflection errors based at least in part on respective ones of the combined bulk temperatures and respective ones of the baseline bulk temperatures; and (h) iteratively implementing (a) through (g) to reduce the respective thermal deflection errors and/or the respective bulk temperature errors toward zero error by adjusting one or more tuning parameters.

The method of any preceding clause, further comprising: calculating, for each one of the regions of interest, a hot free stream temperature and a cold free stream temperature, the hot and cold free stream temperatures being calculated for a given region of interest of the regions of interest based on fluid flowing relative to the component of interest in the given region of interest, and wherein the nodal potential temperature for the node at (e) is determined based at least in part on i) the hot and cold free stream temperatures calculated for the region of interest associated with the given node, and ii) a number of nodes defined for the region of interest associated with the given node.

The method of any preceding clause, wherein the cooling/heating effectiveness for a given one of the regions of interest is determined at (b) by scaling a calculated cooling/heating effectiveness as a function of a number of transfer units using an iterative curve matching technique, and wherein the calculated cooling/heating effectiveness is determined based at least in part on a number of transfer units, a ratio of a minimum mass flow rate of hot fluid streams flowing relative to the component of interest in the given region of interest to a maximum mass flow rate of cold fluid streams flowing relative to the component of interest in the given region of interest, the number of transfer units being determined based at least in part on an overall heat transfer rate at the given region of interest and a minimum mass flow rate of the hot fluid streams and the cold fluid streams.

The method of any preceding clause, wherein the nodal bulk temperature associated a given one of the regions of interest are combined into the combined bulk temperature at (f) according to:

$${T}_{bulk - combined} ( t ) = {\sum }_{i = 1}^{N} {T}_{nodal ( i )} ( t ) - ( N - 1 ) * {T}_{ref}$$

wherein T_{bulk-combined}(t) is the combined bulk temperature for the given region of interest at a given time point, Σᵢ₌^{N} T_{nodal(i)}(t) is the sum of the nodal bulk temperatures associated with the region of interest for the given time point, N is a number of nodes associated with the given region of interest, and T_{ref} is a reference temperature utilized to determine the baseline bulk temperature for the given region of interest.

The method of any preceding clause, wherein determining, for each one of the regions of interest, the respective bulk temperature errors and/or the respective thermal deflection errors at (g) comprises performing at least one: (1) (A) converting each one of the combined bulk temperatures into respective thermal deflections; (B) comparing the respective thermal deflections to respective known thermal deflections; and (C) determining respective thermal deflection errors based at least in part on the comparing; or (2) (A) comparing respective ones of the combined bulk temperatures to respective baseline bulk temperatures; and (B) determining respective bulk temperature errors based at least in part on the comparing of the respective ones of the combined bulk temperatures to the respective baseline bulk temperatures.

A non-transitory computer readable medium comprising computer-executable instructions, which, when executed by one or more processors of a computing system associated with a turbomachine, cause the one or more processors to execute a training module to train a reduced order model that, when trained, is configured to output estimates usable for determining clearances of the turbomachine; wherein, in executing the training module, the one or more processors are configured to: determine, for each region of interest of a component of interest, a cooling/heating effectiveness, the cooling/heating effectiveness for a given one of the regions of interest being determined as a function of a flow rate of fluid streams flowing relative to the component of interest in the given one of the regions of interest; calculate, for each one of the regions of interest, a nodal cooling/heating effectiveness for each node of one or more nodes defined for a given region of interest, the nodal cooling/heating effectiveness for a given node of the one or more nodes being calculated as a function of the cooling/heating effectiveness associated with the region of interest for which the given node is defined; calculate a nodal bulk temperature for each one of the one or more nodes, the nodal bulk temperature for a given node of the one or more nodes being calculated based at least in part on a nodal time constant, a nodal potential temperature determined based at least in part on the nodal cooling/heating effectiveness associated with the given node, and a previous nodal bulk temperature, each of which is associated with the given node; determine, for each one of the regions of interest, a combined bulk temperature, the combined bulk temperature for a given region of interest of the regions of interest being determined by combining the nodal bulk temperatures associated the given region of interest; determine, for each one of the regions of interest, respective bulk temperature errors and/or respective thermal deflection errors based at least in part on respective ones of the combined bulk temperatures and respective ones of the baseline bulk temperatures; and recursively iterate implementation of the training module to reduce the respective thermal deflection errors and/or the respective bulk temperature errors toward zero error by adjusting one or more tuning parameters.

What is claimed is:

1. A system for estimating clearances of a turbomachine, the system comprising:
one or more memory devices; and
one or more processors configured to:
output, from a trained reduced order model (ROM) for each region of interest of one or more components of interest of the turbomachine, an estimated bulk temperature;
determine, at a validation module for each of the regions of interest, a filtered bulk temperature, the filtered bulk temperature of a given component of interest of the one or more components of interest in a given region of interest of the regions of interest being determined based at least in part on the estimated bulk temperature and a measured bulk temperature each associated with the given component of interest at the given region of interest, the measured bulk temperature being determined independently of the trained ROM;
determine, at a clearance estimator for each clearance of interest of the turbomachine, an estimated clearance, the estimated clearance for a given clearance of interest of the clearances of interest being determined based at least in part on the filtered bulk temperatures associated with the region of interest in which the given clearance of interest is positioned; and
perform a control action based at least in part on the estimated clearances.

2. The system of claim 1, wherein the validation module has a Kalman filter and one or more measurement models, and wherein the one or more measurement models provide the measured bulk temperatures to the Kalman filter.

3. The system of claim 2, wherein the one or more measurement models include at least one measurement model for every one of the one or more components of interest.

4. The system of claim 2, wherein, in determining the filtered bulk temperature for the given region of interest, the one or more processors are configured to:
generate, by executing the Kalman filter, an estimated bulk temperature distribution based at least in part on the estimated bulk temperature associated with the given region of interest;
generate, by executing the Kalman filter, a measured bulk temperature distribution based at least in part on the measured bulk temperature associated with the given region of interest;
generate, by executing the Kalman filter, a conditional distribution based at least in part on the estimated bulk temperature distribution and the measured bulk temperature distribution, and
wherein the filtered bulk temperature is determined using the conditional distribution.

5. The system of claim 1, wherein the one or more processors are further configured to:
determine, for at least one of the regions of interest of the one or more components of interest, a weighted inter-region bulk temperature, the weighted inter-region bulk temperature for the at least one region of interest being determined as an average of a first bulk temperature associated with a first region of interest of the regions of interest positioned upstream of the at least one region of interest and a second bulk temperature associated with a second region of interest of the regions of interest positioned downstream of the at least one region of interest; and
determine whether the filtered bulk temperature associated with the at least one region of interest is within a predetermined range of the weighted inter-region bulk temperature.

6. The system of claim 1, wherein, in determining, at the clearance estimator, the estimated clearances for respective clearances of interest of the turbomachine based at least in part on the filtered bulk temperatures, the one or more processors are configured to:
for a given clearance of interest of the clearances of interest,
determine a thermal deflection associated with each component of interest in the region of interest in which the given clearance of interest is positioned;
determine a mechanical deflection associated with each component of interest in the region of interest in which the given clearance of interest is positioned;
determine a total deflection associated with each component of interest in the region of interest in which the given clearance of interest is positioned, the total deflection for a given component of interest in the region of interest in which the given clearance of interest is positioned being determined based at least in part on the thermal deflection and the mechanical deflection associated with the given component of interest, and
wherein the clearance associated with the given clearance of interest is determined as a sum of the total deflections for the respective components of interest that affect the given clearance of interest in a first direction less a sum of the total deflections for the respective components of interest that affect the given clearance of interest in a second direction, wherein the second direction is opposite the first direction.

7. The system of claim 1, wherein the one or more processors are further configured to:
determine, at a clearance validation module for each of the clearances of interest, a filtered clearance, the filtered clearance for a given clearance of interest being determined based at least in part on the estimated clearance and a measured clearance each associated with the given clearance of interest.

8. The system of claim 7, wherein the clearance validation module has a clearance Kalman filter and one or more clearance measurement models, and wherein the one or more clearance measurement models provide the measured clearances to the clearance Kalman filter, and
wherein, in determining the filtered clearance for the given clearance of interest, the one or more processors are configured to:
generate, by executing the clearance Kalman filter, an estimated clearance distribution based at least in part on the estimated clearance associated with the given clearance of interest;
generate, by executing the clearance Kalman filter, a measured clearance distribution based at least in part on the measured clearance associated with the given clearance of interest;
generate, by executing the clearance Kalman filter, a joint clearance distribution based at least in part on the estimated clearance distribution and the measured clearance distribution, and
wherein the filtered clearance is determined using the joint clearance distribution.

9. The system of claim 1, wherein the one or more processors are further configured to:
output, from the validation module, the filtered bulk temperatures to the trained ROM.

10. The system of claim 1, wherein the one or more processors are further configured to:
receive, in the trained ROM, input predictors;
determine, by executing the trained ROM, the estimated bulk temperatures based at least in part on the input predictors and model parameters tuned during training of the trained ROM; and
output, by the trained ROM, the estimated bulk temperatures to the validation module.

11. The system of claim 1, wherein the one or more processors are configured to generate the trained ROM by executing a training module, wherein in executing the training module, the one or more processors are configured to:
(a) determine, for each of the regions of interest of the one or more components of interest of the turbomachine, a baseline bulk temperature;
(b) determine, for each one of the regions of interest, a cooling/heating effectiveness, the cooling/heating effectiveness for a given one of the regions of interest being determined as a function of a flow rate of fluid streams flowing relative to the component of interest in the given one of the regions of interest;
(c) define one or more nodes for each one of the regions of interest;
(d) calculate a nodal cooling/heating effectiveness for each node of the one or more nodes, the nodal cooling/heating effectiveness for a given node of the one or more nodes being calculated as a function of the cooling/heating effectiveness associated with the given node;
(e) calculate a nodal bulk temperature for each one of the one or more nodes, the nodal bulk temperature for a given node of the one or more nodes being calculated based at least in part on a nodal time constant, a nodal potential temperature determined based at least in part on the nodal cooling/heating effectiveness associated with the given node, and a previous nodal bulk temperature, each of which is associated with the given node;
(f) determine, for each one of the regions of interest, a combined bulk temperature, the combined bulk temperature for a given region of interest of the regions of interest being determined by combining the nodal bulk temperatures associated the given region of interest;
(g) determine, for each one of the regions of interest, respective bulk temperature errors and/or respective thermal deflection errors based at least in part on respective ones of the combined bulk temperatures and respective ones of the baseline bulk temperatures; and
(h) iterate implementation of (a) through (g) to reduce the respective thermal deflection errors and/or the respective bulk temperature errors toward zero error by adjusting one or more tuning parameters.

12. The system of claim 1, wherein, in performing the control action based at least in part on the estimated clearances, the one or more processors are configured to:
cause one or more controllable devices of the turbomachine to change an operating point of the turbomachine based at least in part on the estimated clearances.

13. The system of claim 1, wherein, in performing the control action based at least in part on the estimated clearances, the one or more processors are configured to:
determine, upon executing a restart analyzer, whether one or more conditions are satisfied to restart the turbomachine based at least in part on the estimated clearances, and
wherein when the one or more conditions are satisfied, the one or more processors are configured to cause the turbomachine to restart.

14. The system of claim 13, wherein in determining, upon executing the restart analyzer, whether the one or more conditions are satisfied to restart the turbomachine based at least in part on the estimated clearances, the one or more processors are configured to perform at least one of:
i) determine whether the estimated clearances are greater than respective ones of a plurality of required restart clearances; or
ii) determine whether one or more restart conditions are satisfied based at least on one or more restart parameters.

15. The system of claim 14, wherein when the estimated clearances are not greater than the respective ones of the plurality of required restart clearances, the one or more processors are configured to:
determine, by executing a time-to-restart estimator, an estimated time-to-restart the turbomachine based at least in part on a magnitude of a difference between at least one of the estimated clearances and a required restart clearance each associated with a given one of the clearances of interest; and
output the estimated time-to-restart the turbomachine to one or more entities.

16. A method of estimating clearances of a turbomachine, the method comprising:
outputting, from a reduced order model for each region of interest of one or more components of interest of the turbomachine, an estimated bulk temperature;
determining, at a validation module for each of the regions of interest of the one or more components of interest, a filtered bulk temperature, the filtered bulk temperature for a given region of interest of the regions of interest being determined based at least in part on the estimated bulk temperature and a measured bulk temperature determined independently from the reduced order model;
determining, at a clearance estimator, estimated clearances for respective clearances of interest of the turbomachine based at least in part on the filtered bulk temperatures; and
performing a control action based at least in part on the estimated clearances.

17. The method of claim 16, wherein the validation module has a Kalman filter and one or more measurement models, and wherein the one or more measurement models provide the measured bulk temperatures to the Kalman filter, and wherein determining the filtered bulk temperature for the given region of interest comprises:
generating, by executing the Kalman filter, an estimated bulk temperature distribution based at least in part on the estimated bulk temperature associated with the given region of interest;
generating, by executing the Kalman filter, a measured bulk temperature distribution based at least in part on the measured bulk temperature associated with the given region of interest;
generating, by executing the Kalman filter, a conditional distribution based at least in part on the estimated bulk temperature distribution and the measured bulk temperature distribution, and
wherein the filtered bulk temperature is determined using the conditional distribution.

18. The method of claim 16, further comprising:
determining, for at least one of the regions of interest of the one or more components of interest, a weighted inter-region bulk temperature, the weighted inter-region bulk temperature for the at least one region of interest being determined as an average of a first bulk temperature associated with a first region of interest of the regions of interest positioned upstream of the at least one region of interest and a second bulk temperature associated with a second region of interest of the regions of interest positioned downstream of the at least one region of interest; and
determining whether the filtered bulk temperature associated with the at least one region of interest is within a predetermined range of the weighted inter-region bulk temperature.

19. The method of claim 16, further comprising:
determining, at a clearance validation module for each of the clearances of interest, a filtered clearance, the filtered clearance for a given clearance of interest being determined based at least in part on the estimated clearance and a measured clearance each associated with the given clearance of interest.

20. A non-transitory computer readable medium comprising computer-executable instructions, which, when executed by one or more processors of a computing system associated with a turbomachine, cause the one or more processors to:
output, from a trained reduced order model (ROM) for each region of interest of one or more components of interest of the turbomachine, an estimated bulk temperature;
determine, at a validation module for each of the regions of interest, a filtered bulk temperature, the filtered bulk temperature of a given component of interest of the one or more components of interest in a given region of interest of the regions of interest being determined based at least in part on the estimated bulk temperature and a measured bulk temperature each associated with the given component of interest at the given region of interest, the measured bulk temperature being determined independently of the trained ROM;
determine, at a clearance estimator for each clearance of interest of the turbomachine, an estimated clearance, the estimated clearance for a given clearance of interest of the clearances of interest being determined based at least in part on the filtered bulk temperatures associated with the region of interest in which the given clearance of interest is positioned; and
perform a control action based at least in part on the estimated clearances.
